(19) United States
(12) Patent Application Publication
(10) Pub. No.: US 2026/0288887 A1
(43) Pub. Date: Sep. 24, 2026

(54) SYSTEM

(71) Applicant: SoftBank Group Corp., Tokyo (JP)

(72) Inventor: Mamoru TAKADA, Tokyo (JP)

(73) Assignee: SoftBank Group Corp., Tokyo (JP)

(21) Appl. No.: 19/568,856

(22) Filed: Mar. 17, 2026

(30) Foreign Application Priority Data
Mar. 19, 2025 (JP) 2025-045254

(51) Int. Cl. G06F 16/9536; G06F 40/237

(52) U.S. Cl. CPC G06F 16/9536; G06F 40/237

(57) ABSTRACT

A system includes a processor that is configured to analyze, using natural language processing, content to be posted to an information sharing platform and detect offensive content or confidential content in the content to be posted, generate a prompt for instructing a generative artificial intelligence model to generate a warning message based on detected content, and cause the warning message to be displayed to a user, analyze an emotional state of the user by using a sentiment analysis engine, and adjust the generated warning message in consideration of an analysis result of the emotional state of the user, and when posting of the content is selected, generate a prompt for instructing the generative artificial intelligence model to generate a revision proposal that reduces offensiveness or confidentiality of the content to be posted, and cause the revision proposal to be presented to the user.

### CROSS-REFERENCE TO RELATED APPLICATION

This application is based on and claims priority under 35 USC 119 from Japanese Patent Application No. 2025-045254 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In recent years, information sharing platforms such as social networking services have enabled users to easily publish text content to an unspecified number of other users. However, users sometimes post content that includes offensive expressions or confidential information without sufficient awareness of the potential impact on recipients or the risk of information leakage. Conventional systems that merely filter or block such content do not provide adequate support for allowing users to voluntarily adjust their expressions while maintaining the intended meaning of the post. In addition, conventional warning mechanisms generally do not take into account the emotional state of the user at the time of posting, and therefore may fail to present warnings or revision proposals in a manner that is acceptable or effective for users who are in a particular emotional condition, such as anger or distress. Consequently, there is a need for a system that can detect offensive or confidential content in a post, generate an appropriate warning and revision proposal by using a generative artificial intelligence model, and adjust the warning message and revision proposal in consideration of the user's emotional state, thereby supporting safer and more considerate posting behavior.

### SUMMARY

In order to solve the above-described problems, an embodiment of the present invention provides a system comprising a processor. The processor is configured to analyze, using natural language processing, content to be posted to an information sharing platform and to detect offensive content or confidential content in the content to be posted. The processor is further configured to generate a prompt for instructing a generative artificial intelligence model to generate a warning message based on the detected content, and to cause the warning message to be displayed to a user. The processor is further configured to analyze an emotional state of the user by using a sentiment analysis engine, and to adjust the generated warning message in consideration of an analysis result of the emotional state of the user, for example by changing wording, tone, or level of detail of the warning message.

When posting of the content is selected, the processor is configured to generate a prompt for instructing the generative artificial intelligence model to generate a revision proposal that reduces offensiveness or confidentiality of the content to be posted, and to cause the revision proposal to be presented to the user. In certain embodiments, the processor is configured to cause the warning message to be displayed in a predetermined form indicating that the post may be perceived as offensive or may contain confidential information, and to generate, in consideration of the emotional state of the user, a prompt for instructing the generative artificial intelligence model to generate the revision proposal that reduces the offensiveness or confidentiality of the content to be posted, thereby enabling the system to provide context-appropriate guidance and support for safer posting.

The term “information sharing platform” refers to any network-based service or system, including but not limited to social networking services, messaging platforms, forums, or collaboration tools, that enables a user to post, publish, or otherwise share content with one or more other users.

The term “content to be posted” refers to text or text-inclusive information, such as messages, comments, posts, or status updates, that a user intends to submit to an information sharing platform, prior to the content being made publicly or semi-publicly available.

The term “processor” refers to one or more hardware processing units, such as a central processing unit (CPU), a graphics processing unit (GPU), a digital signal processor (DSP), or any combination thereof, configured to execute instructions stored in a memory to perform the functions described herein.

The term “natural language processing” refers to a set of computational techniques or models for processing, analyzing, or understanding human language text, including but not limited to tokenization, part-of-speech tagging, parsing, named entity recognition, sentiment analysis, and text classification.

The term “offensive content” refers to content that includes words, phrases, or expressions that may be perceived as insulting, abusive, harassing, discriminatory, or otherwise inappropriate by a recipient, as determined based on a dictionary, model, rule set, or combination thereof.

The term “confidential content” refers to content that includes information which should not be disclosed to unspecified or unauthorized recipients, such as personal identifiers, financial information, security credentials, or other sensitive data, as determined based on patterns, rules, models, or policy definitions.

The term “prompt” refers to a machine-readable instruction, request, or input sequence provided to a generative artificial intelligence model, specifying at least a task to be performed and contextual information used by the generative artificial intelligence model to generate an output such as text.

The term “generative artificial intelligence model” refers to a machine learning model, such as a large language model or other generative model, that is configured to generate text or other content in response to a prompt, based on parameters learned from training data.

The term “warning message” refers to a message generated or caused to be generated by the system, and presented to a user, that informs the user that the content to be posted may include offensive content or confidential content, and that optionally requests confirmation or selection of a subsequent action by the user.

The term “sentiment analysis engine” refers to a software and/or hardware component configured to analyze text, behavioral signals, or other input related to a user, and to estimate or classify an emotional state or sentiment of the user, such as anger, sadness, neutrality, or positivity.

The term “emotional state of the user” refers to a psychological or affective condition of the user at a given time, inferred by the sentiment analysis engine from textual or other input, and used by the system to adjust at least a warning message or a revision proposal.

The term “revision proposal” refers to alternative text generated or caused to be generated by the generative artificial intelligence model, based on the content to be posted, that is intended to reduce the offensiveness or confidentiality level of the content while preserving at least part of the original meaning or intent.

The term “reduces offensiveness” refers to modifying content in a manner that decreases a likelihood that the content will be perceived as insulting, abusive, harassing, discriminatory, or otherwise inappropriate, for example by replacing offensive expressions with neutral or less intense expressions.

The term “reduces confidentiality” refers to modifying content in a manner that decreases a likelihood of disclosing sensitive or confidential information, for example by masking, anonymizing, generalizing, or omitting specific identifiers or details.

The term “cause the warning message to be displayed” refers to controlling or instructing a user interface component, such as a display device or application interface on a client terminal, to output the warning message in a visible form to the user.

The term “cause the revision proposal to be presented” refers to controlling or instructing a user interface component to output the revision proposal in a form that allows the user to view, review, or select the revision proposal, including but not limited to displaying the revision proposal on a screen.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

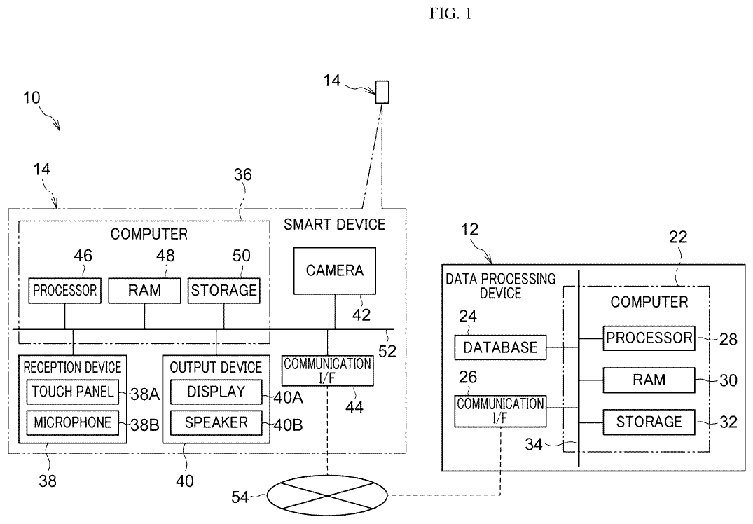

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

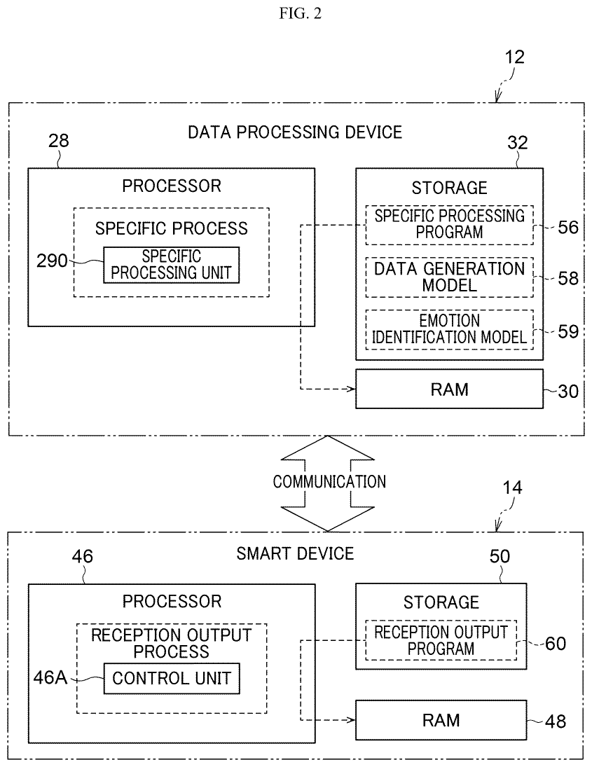

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional content moderation systems deployed on information sharing platforms mainly rely on fixed keyword lists, simple pattern matching, and coarse sentiment analysis. Such systems suffer from several technical limitations in a computer environment. First, static keyword and pattern-based filters frequently produce false positives and false negatives because they cannot robustly account for context, user intent, or rapidly evolving expressions, which results in unstable and inefficient use of processing resources on a server. Second, when a user attempts to post content containing potentially offensive expressions or confidential information, existing systems generally provide only binary blocking or generic warnings without adapting the warning message to the user's emotional state or the specific nature of the detected content. This leads to suboptimal human-computer interaction, repeated resubmissions, and increased computational load for re-analysis on the server side. Moreover, although generative artificial intelligence models are capable of generating nuanced text and context-aware suggestions, conventional systems do not integrate such models into the moderation pipeline in a structured manner. In particular, there is no standardized mechanism in conventional architectures for dynamically constructing and adjusting prompt sentences supplied to a generative artificial intelligence model based on (i) detailed detection results obtained via natural language processing and dictionary/pattern matching, and (ii) a real-time emotion analysis of the user. As a result, the output of the generative artificial intelligence model may be inconsistent, overly generic, or misaligned with the platform's moderation policies, thereby requiring additional post-processing and consuming further computational resources.

Furthermore, existing systems rarely leverage the history of detection results, user reactions to warnings, and subsequent corrections to systematically update the underlying lexical resources and prompt configurations. The absence of such feedback-based learning causes degradation in detection accuracy over time as language usage and confidentiality risks evolve, and prevents the system from improving the efficiency and reliability of its moderation computations. Consequently, the computer system fails to adaptively optimize both the detection pipeline and the generative artificial intelligence interaction, resulting in degraded performance, increased latency, and lower accuracy in detecting and mitigating offensive or confidential content.

Accordingly, there is a need for a computer-implemented content checking system that: (1) combines structured natural language processing, dictionary-based and pattern-based detection, and generative artificial intelligence in a coordinated pipeline; (2) dynamically constructs and adjusts prompt sentences for the generative artificial intelligence model using detection results and emotion analysis results; (3) automatically generates tailored warning messages and correction proposals; and (4) uses logging and history information to update lexical resources and prompt configurations. Such a system should improve the underlying computer technology by enhancing detection accuracy, reducing redundant processing, stabilizing generative model behavior, and improving the efficiency and robustness of content moderation in an information processing environment.

The specific processing by the specific processing unit 290 of the data processing device 12 in Example 1 is realized by the following means.

The present invention provides a server comprising a processor configured to receive posting text information from a user terminal associated with an information sharing platform, input the posting text information to a text information analysis unit using a natural language processing technique, and perform at least morphological analysis, punctuation processing, normalization processing, and syntactic analysis to extract a word sequence and a phrase sequence from the posting text information; compare the extracted word sequence and phrase sequence with word information stored in a word information storage unit, the word information storage unit storing word information corresponding to offensive content and confidential content, apply rule-expression patterns related to confidential content to the posting text information to detect structured number information and identification information, and extract candidate information corresponding to offensive content or confidential content; generate, on the basis of the candidate information, a prompt sentence that instructs a generative artificial intelligence model to generate warning text information for providing a caution to a user, transmit the prompt sentence to the generative artificial intelligence model, obtain the warning text information generated by the generative artificial intelligence model, and transmit the warning text information to the user terminal for display; obtain an emotion analysis result from an emotion analysis engine that analyzes an emotional state of the user on the basis of at least one of an input operation history and biological information of the user, and, on the basis of the candidate information and the emotion analysis result, adjust at least one of a word configuration and an output condition of the prompt sentence to be input to the generative artificial intelligence model so as to change at least one of an expression intensity and an expression style of the warning text information; when the user selects execution of posting after the warning text information is displayed, generate correction conditions including the candidate information and the emotion analysis result, generate a correction prompt sentence that instructs the generative artificial intelligence model to generate a correction proposal that reduces at least one of aggressiveness and confidentiality of the posting text information on the basis of the correction conditions, transmit the correction prompt sentence to the generative artificial intelligence model, obtain the correction proposal generated by the generative artificial intelligence model, and present the correction proposal to the user terminal; associate at least one of corrected posting text information transmitted from the user terminal and posting text information selected by the user to be posted without correction with a detection result of the candidate information and the emotion analysis result, and record the association as history information in a storage unit; and update, on the basis of the history information, at least one of the word information stored in the word information storage unit and configuration conditions of the prompt sentence so as to improve detection accuracy of the offensive content or the confidential content and generation accuracy of the correction proposal. This enables the computer-implemented moderation pipeline to more accurately and efficiently detect offensive and confidential content, to generate context-sensitive and emotion-aware warning messages and correction proposals via stable interaction with the generative artificial intelligence model, and to adaptively refine lexical resources and prompt configurations over time, thereby improving the technical performance, robustness, and resource efficiency of the server in processing user-generated text.

The term “posting text information” refers to character-based information representing content that a user intends to post on an information sharing platform, including words, phrases, sentences, and symbols entered via a user terminal.

The term “user terminal” refers to an information processing device operated by a user, such as a client computer, a handheld device, or a communication terminal, that is capable of transmitting and receiving data to and from a server over a communication network.

The term “information sharing platform” refers to an information processing system or service that enables multiple users to publish, view, and exchange content, such as messages, comments, or posts, via a communication network.

The term “text information analysis unit” refers to a functional component implemented by hardware and/or software that analyzes posting text information using natural language processing to produce intermediate analysis results such as tokens, word sequences, and phrase sequences.

The term “natural language processing technique” refers to a computational technique by which a computer interprets and processes human language text, including operations such as tokenization, morphological analysis, part-of-speech tagging, syntactic parsing, and semantic analysis.

The term “morphological analysis” refers to a process of decomposing text into minimal linguistic units, such as words or morphemes, and assigning attributes such as part-of-speech tags to the decomposed units.

The term “punctuation processing” refers to a process of analyzing, normalizing, or handling punctuation symbols within text, including segmentation of sentences and adjustment of repeated punctuation for subsequent analysis.

The term “normalization processing” refers to a process that converts text into a canonical form, including at least unifying character encodings, converting full-width characters to half-width characters where appropriate, and standardizing letter case and whitespace.

The term “syntactic analysis” refers to a process of determining structural relationships between words or phrases within a sentence, including building syntactic trees or dependency structures.

The term “word sequence” refers to an ordered set of word units obtained from posting text information through natural language processing, which may include individual words and their positions in the text.

The term “phrase sequence” refers to an ordered set of multi-word expressions or n-grams obtained from posting text information, where each phrase consists of two or more word units that are treated as a single logical unit for analysis.

The term “word information storage unit” refers to a storage component, implemented by a memory device or a storage device, that stores word information including entries associated with offensive content and confidential content.

The term “word information” refers to data entries that associate specific words, phrases, or patterns with categories such as offensive content or confidential content, and may further include attributes such as severity or type.

The term “offensive content” refers to content that includes expressions, words, or phrases likely to be perceived as abusive, insulting, discriminatory, or otherwise inappropriate by recipients.

The term “confidential content” refers to content that includes information which should not be publicly disclosed, such as personal identifiers, financial numbers, internal project names, or other sensitive data that may cause privacy or security risks.

The term “rule-expression pattern” refers to a machine-readable representation of a rule, including but not limited to a regular expression or pattern-matching rule, that is used to detect structured information such as numbers, codes, or identifiers in text.

The term “structured number information” refers to numeric information in a specific structured format, such as credit card numbers, identification numbers, or account numbers, that can be detected by applying rule-expression patterns.

The term “identification information” refers to data that can identify an individual person, entity, or resource, including but not limited to identifiers such as user IDs, account IDs, or unique codes.

The term “candidate information” refers to information elements, such as words, phrases, or detected patterns, that have been identified by a detection process as potential offensive content or confidential content and are subject to further processing.

The term “generative artificial intelligence model” refers to a computational model, such as a machine-learned language model, that can generate text as output in response to an input prompt sentence, based on statistical or neural network-based learning.

The term “prompt sentence” refers to text or structured input supplied to a generative artificial intelligence model, which includes instructions, conditions, and contextual information used to control and specify the output of the model.

The term “warning text information” refers to text generated to provide a caution or notification to a user, indicating that the posting text information may include offensive content or confidential content, and optionally suggesting that the user review or modify the content.

The term “emotion analysis engine” refers to a functional component implemented by hardware and/or software that analyzes input data related to a user, such as operation history or biological information, to estimate or determine an emotional state of the user.

The term “emotional state” refers to an estimated condition of a user such as anger level, stress level, calmness, or other affective states derived by the emotion analysis engine from observed data.

The term “input operation history” refers to data reflecting a user's operations on the user terminal, such as key input sequences, touch patterns, input speed, or correction frequency, which can be used as features for emotion analysis.

The term “biological information” refers to measurable physiological signals related to a user, such as heart rate, skin conductance, facial expressions, or voice characteristics, that can be used to estimate the emotional state of the user.

The term “expression intensity” refers to a magnitude or strength of the wording in warning text information or posting text information, such as the degree of directness, harshness, or emphasis.

The term “expression style” refers to a manner or tone of wording, such as polite, neutral, strict, or friendly, used in warning text information or posting text information.

The term “correction conditions” refers to conditions or parameters generated based on candidate information and emotion analysis results, which are used to instruct a generative artificial intelligence model on how to modify posting text information.

The term “correction prompt sentence” refers to a prompt sentence that specifically instructs a generative artificial intelligence model to generate a correction proposal for posting text information, including conditions for reducing aggressiveness or confidentiality.

The term “correction proposal” refers to modified text proposed by a generative artificial intelligence model for replacing or revising posting text information so as to reduce offensive content or confidential content while preserving user intent where possible.

The term “history information” refers to recorded data that associates posting text information, detection results, emotion analysis results, user actions, and system responses over time, used for subsequent analysis and system improvement.

The term “storage unit” refers to a hardware or virtual device capable of storing data, such as a memory device, a mass storage device, or a database system, that retains history information, word information, and configuration conditions.

The term “configuration conditions of the prompt sentence” refers to parameters or rules that define how a prompt sentence is constructed, including structure, wording, required fields, and output format specifications for the generative artificial intelligence model.

The term “detection accuracy” refers to a performance measure indicating how correctly the system identifies offensive content and confidential content in posting text information, including rates of true detection and reduced false detections.

The term “generation accuracy of the correction proposal” refers to a performance measure indicating how appropriately and reliably the generative artificial intelligence model produces correction proposals that conform to specified conditions and moderation policies.

In one embodiment, a server implements the claimed system as a network-accessible content checking service for an information sharing platform. The server includes at least one general-purpose processor, a main memory, a nonvolatile storage device, and a network interface. The processor executes program modules stored in the storage device and loaded into the main memory. The program modules include a web server module, an application logic module, a natural language processing (NLP) module, a dictionary and pattern matching module, an emotion analysis module, and a generative AI interaction module. The server communicates with one or more terminals operated by users via a communication network such as the Internet.

The terminal is, for example, a smartphone, a tablet, or a personal computer equipped with a display, an input device, a local processor, and a communication interface. The terminal executes a client application, such as a native application or a web application running in a browser, that provides a user interface for composing, displaying, and editing posting text information. The terminal transmits posting text information and related metadata to the server over a secure communication channel such as HTTPS, and receives warning text information and correction proposals from the server for display to the user.

The server uses the NLP module to analyze posting text information. The NLP module is realized, for example, by an NLP library executing on the processor, such as a dependency parser and a tokenizer similar to those provided by common open-source frameworks. The server stores the NLP model parameters in the nonvolatile storage device and loads them into memory for inference. The NLP module maintains an internal data structure in memory representing each post as a token sequence and a syntactic graph. The server represents each token as a record that includes at least an index in the original text, a normalized surface form, a lemma, and a part-of-speech tag. The server represents syntactic relationships as directed edges between token indices with labels indicating grammatical roles.

The server uses the dictionary and pattern matching module to detect offensive content and confidential content. The server maintains a word information storage unit in the form of a database table or a key-value store, in which entries map normalized phrases to category labels such as “offensive” or “confidential”, and may further include severity levels. The server loads a subset of this word information into an in-memory index implemented, for example, as a hash map keyed by phrase strings. For confidential content that follows structured formats, such as identification numbers or numeric codes, the server maintains rule-expression patterns using a regular-expression engine. The server applies these patterns to the posting text information to detect structured number information and identification information.

The server uses a specific data structure for candidate information. Each element of candidate information is a record including: a text span (start index and end index in the posting text information), a matched phrase or pattern, a category (offensive or confidential), a severity value, and an optional context window (neighboring tokens or sentences). By explicitly storing context windows, the server is able to apply context-dependent rules, for example, to differentiate a harmless mention from a targeted insult. The server stores candidate information in a list or array structure and passes it between modules in memory, thereby avoiding repeated scans of the original text and improving processing speed.

The server constructs prompt sentences for a generative AI model using the generative AI interaction module. The server deploys a generative AI model as a separate inference service, which may execute on a specialized hardware configuration including one or more graphics processing units (GPUs). In one embodiment, the generative AI model is a transformer-based neural network including multiple encoder-decoder layers, multi-head self-attention mechanisms, and learned token embeddings. The server stores model hyperparameters such as the number of layers, hidden dimension size, number of attention heads, and vocabulary size in configuration data. The server uses an inference API to send textual prompt sentences and receive generated warning text information and correction proposals.

The server does not simply send the raw posting text information to the generative AI model. Instead, the server composes the prompt sentence based on a combination of the posting text information, the candidate information, and an emotion analysis result. The server includes in the prompt sentence explicit instructions specifying: (i) the type of content to be detected (offensive expressions, confidential information), (ii) the required output format (for example, a rewritten safer version of the entire post), and (iii) constraints on tone and style. For example, the server may generate a prompt sentence such as:
“Analyze the following SNS post and identify any offensive expressions or confidential information. Then list the problematic phrases and propose a safer alternative wording for the entire post. Post: ‘This product is the worst! I want to return it!’”

In another example, when confidential patterns are detected, the server may generate a prompt sentence such as:
“Please review the following user post for offensive language and possible confidential information (such as personal IDs, credit card numbers, or internal project names). If such content is found, generate a rewritten version that removes or generalizes the sensitive parts while keeping the user's main intent. Post: ‘Our client's credit card number is 1234-5678-9012-3456, and this service is the worst.’”

By generating these structured prompt sentences, the server controls the generative AI model in a way that constrains the model's behavior and reduces variability in outputs. The server thereby improves the stability and predictability of generative inference, which is a technical improvement in model integration compared to unstructured, ad hoc prompts.

The server uses an emotion analysis engine to determine an emotional state of the user. The server may receive from the terminal data related to an input operation history, such as key input intervals, backspace frequency, or accelerometer data indicating device shaking, and may receive biological information if available, such as heart rate or skin conductance. The emotion analysis engine extracts numeric features from these signals and applies a trained classifier model, such as a neural network or a gradient-boosting model, to estimate an anger level or stress level. In an embodiment, the emotion analysis engine uses a neural network with several dense layers, an activation function such as rectified linear unit, and an output layer representing multiple emotion intensity scores. The server trains this model offline using supervised learning, with labeled datasets of operation patterns and physiological signals mapped to emotional states. The server uses an error function such as cross-entropy and performs weight updates using gradient descent or a variant such as Adam, with training data augmentation that introduces noise into input features to improve robustness.

The server uses the emotion analysis result to adjust the configuration of prompt sentences. When the emotion analysis engine indicates a high anger level, the server explicitly adds conditions to the prompt sentence requiring calmer wording and de-escalation. For example, the server may construct a prompt sentence of the following form:

“The user appears to be in a highly angry state. Rewrite the following post into a calmer and more neutral expression, and remove or generalize any confidential information. Keep the main factual content. Post: ‘This product is the worst! I want to return it!“ ” In a lower anger or neutral state, the server may request a more minimal rewrite, such as:
“Suggest a slightly softer alternative wording for the following post, without significantly changing the meaning. Post: ‘This product is the worst! I want to return it!’”

By changing the wording and constraints of the prompt sentence in response to the emotion analysis result, the server systematically controls the behavior of the generative AI model according to a nonconventional rule set. This control mechanism is not a mere automation of human moderation but a specific computer-implemented technique that reduces unnecessary rewrites, reduces redundant model calls, and stabilizes output quality, which yields an improvement of computational efficiency and precision in the moderation pipeline.

The server also uses historical data to update the word information storage unit and prompt configuration conditions. When the server receives corrected posting text information from the terminal or confirmation that the user has posted without modification, the server stores an association between the original posting text information, the candidate information, the emotion analysis result, the warning text information, and the user's final decision in a storage unit. The server periodically analyzes this history information to identify dictionary entries that frequently produce false positives or false negatives, and to detect new phrases that often appear in posts flagged as problematic. The server updates the word information by adding new phrases, adjusting severity values, and removing outdated entries. The server also analyzes how different prompt sentence templates affect the quality and acceptability of generated correction proposals, and updates configuration conditions accordingly, such as adjusting typical phrase patterns in the prompt or emphasizing specific constraints like “do not add new factual information.”

This feedback loop enables the server to modify internal data structures and parameters over time without requiring a complete retraining of all models. The technical effect is an improvement in detection accuracy and a reduction in computational cost, because better dictionaries and better prompt configurations reduce the number of unnecessary or ambiguous model inferences and subsequent user re-tries.

From a technical standpoint, the server's processing differs from mere human judgment or simple automation in several aspects. First, the server uses combined symbolic and statistical processing: dictionary and pattern matching complements learned models. The server first performs efficient deterministic filtering using in-memory hash maps and regular-expression engines, which are optimized for pattern lookup. Only when these modules detect candidate information does the server invoke the generative AI model, which is computationally more expensive. This conditional invocation reduces the average processing time per post and reduces network traffic between the server and the generative AI inference backend, thereby decreasing overall resource consumption.

Second, the server employs a structured internal representation of both detection results and user emotional state as explicit numeric and symbolic features that inform prompt generation. The server does not simply “ask the model” in an abstract way; instead, the server encodes constraint logic in the prompt sentence, based on algorithms that select which candidates to mention, how to describe them, and what rewrite objectives to impose. This hybrid approach leads to more deterministic and reproducible behavior of the system, which is a technical improvement over unstructured natural language control of a generative model.

Third, the server improves data management and communication efficiency by storing posting text information, candidate information, emotion analysis results, and user decisions in an integrated data schema. The server can compress and index this history information for fast retrieval when retraining or updating dictionaries and prompt templates. For example, the server may index records by phrase, severity, and user reaction, enabling targeted updates.

This design reduces the amount of data that must be scanned for each update and thus improves the efficiency of periodic maintenance operations on the moderation system.

In one variation, the terminal locally pre-processes posting text information before sending it to the server. The terminal may perform basic character normalization or tokenization to reduce bandwidth, for example, by encoding posts as token IDs instead of raw text. The server then decodes token IDs and performs the remaining NLP steps. This arrangement can further reduce communication load and latency in high-throughput environments.

In another variation, the generative AI model is implemented as a smaller, on-premise model optimized for low-latency inference. The server may use a transformer architecture with reduced depth and width, quantized weights, and pruning applied to attention heads to reduce computational cost. The server can then apply model distillation, training a smaller student model to approximate the behavior of a larger teacher model. These architectural choices enable faster inference, particularly when the server must handle a large volume of posts.

In yet another embodiment, the emotion analysis engine executes partially on the terminal. The terminal collects input operation history and biological information through device-specific sensors, computes preliminary features, and sends only aggregated features to the server. This division of labor reduces the amount of raw biometric data transmitted, contributes to privacy protection, and reduces server-side computational load by offloading feature extraction to the terminal's local processor.

By combining these components—NLP-based detection, dictionary and pattern matching, emotion analysis, structured prompt generation, and adaptive updates—the server achieves a technical advantage over conventional systems. The causal relationship between the design and the effects can be summarized as follows: enriched internal representations and pre-filtering reduce unnecessary generative inferences; emotion-aware prompt configuration yields outputs that are more acceptable and thus require fewer user edits; and feedback-based adaptation of lexical resources and prompts improves detection and rewriting accuracy over time. Consequently, the system reduces average processing time, improves accuracy of offensive and confidential content detection, decreases communication overhead with the generative AI backend, and stabilizes the quality of generated warning text information and correction proposals. These improvements are realized through specific computer-implemented structures and algorithms, rather than through mere automation of human decision-making.

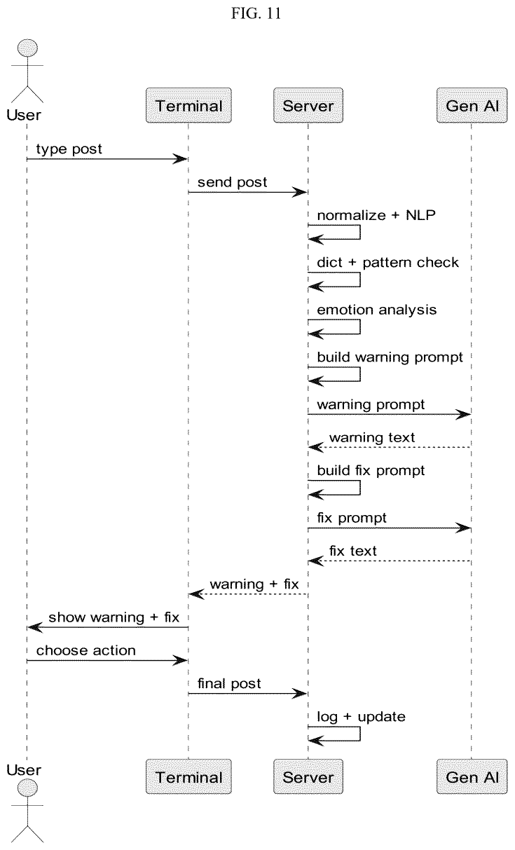

The following describes the processing flow using FIG. 11.

### Step 1:

The user inputs posting text information on the terminal.

The terminal receives character strings typed by the user into an input field of a client application and temporarily stores the text in local memory. As input, the terminal obtains raw keystroke events and converts them into a text buffer such as “This product is the worst! I want to return it!”. The terminal may also record input operation history, such as key press timestamps and correction operations. As output, the terminal generates a structured message including the posting text information and optional metadata (for example, user identifier, device identifier, and operation history summary) to be sent to the server.

### Step 2:

The terminal transmits posting text information to the server.

The terminal takes the structured message from Step 1 as input and encapsulates it in a network request, for example an HTTPS POST request to a server API endpoint. The terminal performs data serialization to convert the internal representation into a transmissible format and attaches headers indicating content length and encoding. As output, the terminal sends the posting text information and metadata through a communication interface to the server and waits for a response containing analysis results or warnings.

### Step 3:

The server receives and parses posting text information.

The server receives the network request from the terminal as input through a network interface. The server invokes a web server module to parse the request header and body, deserialize the data, and extract the posting text information and associated metadata. The server may assign a unique request identifier and log the reception time. As output, the server produces an internal data structure representing the post (for example, a record containing text, user ID, and session information) stored in main memory for further processing.

### Step 4:

The server performs normalization and basic text preprocessing.

The server takes the posting text information extracted in Step 3 as input. The server applies normalization processing, including Unicode normalization, conversion of full-width characters to half-width characters where appropriate, standardization of letter case, and trimming of leading and trailing whitespace. The server may also compress repeated punctuation (for example, “!!!” to “!”) and unify line breaks. These operations are implemented using string manipulation functions on the processor. As output, the server stores a normalized text string that serves as the basis for subsequent NLP analysis.

### Step 5:

The server performs tokenization and syntactic analysis.

The server uses the normalized text from Step 4 as input and passes it to the NLP module.

The server executes tokenization to split the text into tokens (words, punctuation marks) and performs morphological analysis to assign part-of-speech tags and lemmas to each token. The server then performs syntactic analysis to construct a dependency graph or parse tree, computing relationships between tokens. The data processing includes iterating over the text, matching character sequences to lexical patterns, and applying parsing algorithms such as transition-based or chart parsing. As output, the server produces a structured representation including a token list with attributes and a syntactic structure, stored in memory as a text analysis object.

### Step 6:

The server extracts word sequences and phrase sequences.

The server takes the text analysis object from Step 5 as input. The server scans the token list to generate word sequences (single tokens) and phrase sequences (multi-token n-grams). The server constructs candidate phrases by sliding a window of length 2 or more over the token sequence and concatenating token surface forms or lemmas. The server filters out function words and stopwords using a predefined list to focus on content-bearing units. As output, the server generates a list of candidate word sequences and phrase sequences, each associated with its position in the posting text information.

### Step 7:

The server performs dictionary-based detection of offensive and confidential content.

The server uses the candidate word sequences and phrase sequences from Step 6 as input and references the word information storage unit. The server executes lookups in an in-memory index or database table to determine whether each candidate matches a stored entry labeled as offensive or confidential. This involves computing hash values for phrases or issuing queries to the storage unit. The server assigns category labels and severity scores according to matched entries. As output, the server generates a preliminary set of candidate information records, each indicating a matched phrase, category, severity, and text span.

### Step 8:

The server performs pattern-based detection of structured confidential information.

The server takes the normalized posting text information from Step 4 as input and applies rule-expression patterns for confidential data, such as patterns for identification numbers or numeric codes. The server uses a regular expression engine to scan the text for sequences that match these patterns. Each match triggers the creation of a candidate information record with category “confidential” and an appropriate severity level. As output, the server produces additional candidate information records, which the server merges with the records from Step 7 into a combined candidate information list.

### Step 9:

The server aggregates and refines candidate information.

The server uses the combined candidate information list from Steps 7 and 8 as input. The server may merge overlapping spans, reconcile multiple matches on the same phrase, and apply rule-based adjustments; for example, the server may decrease severity if an offensive term appears in a quoted or self-reflective context identified by the syntactic structure. The server calculates overall indicators, such as maximum severity and counts per category, by iterating over the candidate information and aggregating numeric values. As output, the server produces a refined candidate information set and summary metrics indicating whether the posting text information requires a warning.

### Step 10:

The server computes an emotion analysis result for the user.

The server takes input operation history and biological information, if available, from the terminal as input features. The server applies preprocessing, such as normalization of timing values, smoothing of sensor signals, and extraction of statistical descriptors (for example, mean key interval, variance of touch pressure). The server feeds the resulting feature vector into the emotion analysis engine, which executes a classifier model to estimate levels of anger, stress, or other emotional states. This involves forward propagation through a trained neural network or similar model, performing matrix multiplications and activation function evaluations. As output, the server generates an emotion analysis result that includes numeric emotion scores and possibly categorical labels such as “high anger” or “low stress”.

### Step 11:

The server determines whether to generate a warning and correction prompt.

The server takes the refined candidate information set from Step 9 and the emotion analysis result from Step 10 as input. The server compares these inputs against predefined thresholds and policy rules; for example, if any confidential candidate has high severity, or if multiple offensive candidates exist, the server decides that a warning is necessary. The server also determines the strength and style of the warning based on emotion scores. This decision-making is implemented as conditional branching in the application logic. As output, the server produces control flags indicating whether to generate warning text information and whether to request a correction proposal from the generative AI model.

### Step 12:

The server constructs a prompt sentence for warning text information.

The server uses the posting text information, the refined candidate information, the emotion analysis result, and the control flags from Step 11 as input. The server selects a prompt template from stored templates and fills template placeholders with concrete values such as the original post text and a description of detected issues. For example, the server may generate a prompt sentence:
“Analyze the following SNS post and identify any offensive expressions or confidential information. Then generate a short warning message to notify the user that the post may be problematic. Use polite and clear language. Post: ‘This product is the worst! I want to return it!’”
When the emotion analysis result indicates high anger, the server modifies the template to request more empathetic wording. The server concatenates instruction sentences and post content into a single string. As output, the server produces a fully formed prompt sentence for the generative AI model to generate warning text information.

### Step 13:

The server requests warning text information from the generative AI model.

The server takes the prompt sentence from Step 12 as input. The server invokes the generative AI interaction module, which formats the prompt sentence for the inference API and sends it via a network call to the generative AI backend. The backend executes the generative AI model's inference process using the given prompt as input token sequence, performs neural network computations, and returns generated text as output. The server receives this generated text, parses any structural markers if specified, and extracts the warning text information. As output, the server produces warning text information ready for delivery to the terminal.

### Step 14:

The server optionally constructs a prompt sentence for a correction proposal.

The server uses the posting text information, the refined candidate information, the emotion analysis result, and the control flags from Step 11 as input. When a correction proposal is required, the server selects a correction template. For example, the server may generate a prompt sentence:
“Rewrite the following user post so that it remains factually accurate but reduces offensive expressions and removes or generalizes any confidential information. Make the tone calmer and suitable for a public audience. Post: ‘This product is the worst! I want to return it!” If confidential candidates are present, the server adds explicit instructions such as “Replace credit card numbers with a generic placeholder.” The server again concatenates instruction text and post content to form a single prompt sentence. As output, the server generates a correction prompt sentence for use with the generative AI model.

### Step 15:

The server requests a correction proposal from the generative AI model.

The server uses the correction prompt sentence from Step 14 as input when a correction proposal is needed. The server calls the inference API of the generative AI backend, sending the correction prompt sentence and any required parameters. The backend runs the generative AI model to produce a rewritten version of the post. The server receives the generated text, performs basic validation (for example, checking that required confidential patterns are removed by reapplying detection logic), and may adjust formatting. As output, the server obtains a correction proposal string to be presented to the user as an alternative to the original posting text information.

### Step 16:

The server sends warning text information and correction proposal to the terminal.

The server takes the warning text information from Step 13 and, if available, the correction proposal from Step 15 as input. The server packages these results into a response message, including metadata such as categories and severity of detected issues. The server serializes this data and sends an HTTPS response back to the terminal. As output, the terminal receives a structured message that contains warning text information and optionally a correction proposal for display.

### Step 17:

The terminal displays the warning text information and correction proposal.

The terminal receives the server's response from Step 16 as input. The terminal parses the response, extracts the warning text information and the correction proposal, and updates the user interface. The terminal displays a warning dialog, for example containing text such as “This post may be perceived as offensive. Do you still want to post it?” along with the generated warning text information. If a correction proposal is present, the terminal shows the alternative wording and may provide a control to apply it to the input field. As output, the terminal renders the warning and proposal on the display and waits for user interaction.

### Step 18:

The user selects an action based on the displayed information.

The user views the warning text information and the correction proposal on the terminal screen as input. The user decides whether to keep the original posting text information, to adopt the correction proposal, or to manually edit the text. The user then performs an explicit operation, such as pressing a “Use suggestion” button, editing the text in the input field, or pressing a “Post anyway” button. As output, the user causes the terminal to generate updated posting text information and a choice indicator, which will be transmitted to the server.

### Step 19:

The terminal transmits the final posting decision to the server.

The terminal takes the updated posting text information and the user's choice (for example, “modified by user”, “accepted correction proposal”, or “no modification”) as input. The terminal constructs a new network request containing these values and may include a reference to the original request identifier. The terminal sends this request to the server via the communication interface. As output, the server receives the final posting decision and the final version of the posting text information for logging and, if allowed, for forwarding to the information sharing platform.

### Step 20:

The server logs history information and updates internal resources.

The server uses the final posting text information from Step 19, the candidate information from Steps 7-9, the emotion analysis result from Step 10, and the generative outputs from Steps 13 and 15 as input. The server writes an entry into the storage unit that associates these data items, thereby forming history information. The server may periodically process batches of these history entries to update the word information storage unit and prompt configuration conditions. This processing includes statistical analysis such as counting how often a phrase appears in posts flagged as offensive and calculating acceptance rates of correction proposals. As output, the server adjusts dictionary entries, severity thresholds, and parts of prompt templates, leading to refined detection behavior and improved generative AI control in subsequent processing.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional content moderation for information sharing platforms typically relies on fixed keyword filters, static rule sets, or manually crafted classifiers executed on a server. Such approaches suffer from several technical limitations. Static keyword filters frequently yield false positives and false negatives because they cannot robustly interpret context, paraphrasing, or nuanced expressions, and they are difficult to maintain as language usage evolves. Rule-based systems often operate on raw character sequences or simple tokens, without a structured natural language processing pipeline, which results in inefficient processing, limited scalability to large vocabularies and complex patterns, and increased processing latency.

Further, traditional systems generally provide one-way blocking or generic warnings (for example, rejecting a post or displaying a simple alert) without technically integrating a dynamic text generation mechanism that can produce safe alternatives tailored to the specific detected risk. As a result, users are left to manually revise their content, often by trial and error, which increases server load due to repeated submissions and re-checks, and leads to a poor user experience. Moreover, existing systems rarely implement a closed-loop technical workflow in which the server automatically (i) analyzes the draft, (ii) identifies precise problematic spans with position information, (iii) generates a structured prompt sentence, (iv) invokes a generative artificial intelligence model to obtain candidate modifications, and (v) re-validates the generated output against the same detection logic before permitting posting.

Additionally, known architectures do not sufficiently address the technical problem of safely and efficiently orchestrating interactions between a natural language processing module, a detection engine using dictionary and pattern matching, a generative artificial intelligence model, and a user terminal within a single, coherent server-side control flow. In particular, they lack mechanisms for dynamically adjusting prompt sentences according to detected risk types and levels, and for programmatically validating generative model outputs using the same detection resources, thereby leaving residual offensive or confidential information in generated suggestions.

Accordingly, there is a need for an improved computer-implemented system that technically enhances the way a server analyzes user-generated text, detects offensive expressions and confidential information, automatically generates and refines prompt sentences for a generative artificial intelligence model, re-checks model outputs, and guides the user toward safe posting, all within an integrated and efficient processing pipeline. Such a system should reduce misclassification, provide accurate localization of problematic content, minimize residual risk in generated revisions, and improve overall computational efficiency and reliability of content safety processing on information sharing platforms.

The specific processing by the specific processing unit 290 of the data processing device 12 in Application Example 1 is realized by the following means.

The present invention provides a server comprising a processor configured to acquire character string data representing a posting draft from a user terminal, preprocess the character string data using a natural language processing component to segment the character string data into linguistic units including at least one of morpheme units and phrase units, compare words and consecutive words in the preprocessed character string data with dictionary information stored in a storage device, the dictionary information associating vocabulary entries with offensive expressions and confidential information, and with regular expression information representing patterns of confidential information, determine, based on the comparison, presence or absence and position information of the offensive expressions or the confidential information in the character string data, and generate detection result data including a determination result and a risk level, construct, based on the detection result data, a prompt sentence defining warning content and a modification policy in accordance with whether the posting content is offensive or confidential, and generate the prompt sentence as input data to a generative artificial intelligence model, transmit the prompt sentence to the generative artificial intelligence model, acquire response character string data from the generative artificial intelligence model serving as a candidate modification proposal for reducing offensiveness or confidentiality of the posting content, and, when necessary, re-compare the response character string data with the dictionary information and the regular expression information to inspect remaining presence of the offensive expressions or the confidential information in the response character string data, specify, based on the detection result data and the response character string data, problem portions included in the posting draft as display position information, generate display control information for visually emphasizing the problem portions, generate presentation information including a warning message indicating a possibility that the posting content is offensive or confidential and including the candidate modification proposal, and transmit the presentation information to the user terminal, receive, from the user terminal, at least one of an acceptance or a rejection of the candidate modification proposal and modified character string data edited by a user, execute again the preprocessing and the comparison for the modified character string data, determine whether the modified character string data satisfies a predetermined criterion, generate, based on a determination result, posting permission information or additional warning information, and generate transmission control information for transmitting the modified character string data to an information sharing service based on the posting permission information. This enables a technically integrated and iterative content safety workflow in which the server precisely localizes offensive expressions and confidential information, dynamically constructs and adjusts prompt sentences for the generative artificial intelligence model according to detected risk, validates model-generated revisions using the same detection resources, and efficiently guides user-generated content into a state suitable for safe posting, thereby improving accuracy, robustness, and computational efficiency of content moderation on the platform.

The term “character string data” refers to digital data representing a sequence of characters, symbols, or text elements that together form at least part of a posting draft generated by a user.

The term “posting draft” refers to text content composed by a user and intended for transmission to, and display on, an information sharing service, prior to final submission or publication.

The term “user terminal” refers to an information processing device operated by a user, including at least one of a mobile device, a desktop device, and a web-enabled device, that transmits a posting draft to a server and displays responses from the server.

The term “preprocessing” refers to automated operations performed on character string data prior to higher-level analysis, including at least one of tokenization, segmentation, normalization, and linguistic annotation.

The term “natural language processing component” refers to a software module or set of modules executed by a processor to analyze human language text, including functions such as tokenization, morphological analysis, phrase segmentation, part-of-speech tagging, and related operations.

The term “linguistic units” refers to analysis units obtained from character string data by the natural language processing component, including at least one of tokens, morphemes, words, and phrases.

The term “morpheme units” refers to minimal meaningful units of language obtained from character string data by morphological analysis, each representing at least one semantic or grammatical function.

The term “phrase units” refers to groups of one or more morphemes or words that are treated as a syntactic or semantic segment, such as noun phrases or verb phrases, in the analysis of character string data.

The term “dictionary information” refers to structured data stored in a storage device that associates lexical entries, such as words or multi-word expressions, with metadata including classification labels indicating at least offensive expressions and confidential information.

The term “storage device” refers to a hardware or virtual storage resource, including at least one of a memory device and a persistent storage device, that stores dictionary information, regular expression information, and related data used by the processor.

The term “vocabulary entries” refers to stored textual items, including at least words and multi-word expressions, which are used for matching against portions of character string data in order to detect target categories such as offensive expressions or confidential information.

The term “offensive expressions” refers to words, phrases, or combinations thereof that are predetermined to be abusive, aggressive, insulting, or otherwise inappropriate under at least one content policy.

The term “confidential information” refers to any information that may identify or expose sensitive data related to at least individuals or organizations, including at least contact identifiers, financial identifiers, and location identifiers.

The term “regular expression information” refers to pattern descriptors and associated metadata expressed in a formal pattern language, configured to match structured text formats associated with confidential information, such as numerical sequences and formatted identifiers.

The term “patterns of confidential information” refers to structural and lexical patterns, including at least numerical formats, character sequences, and symbol arrangements, that are used to automatically detect confidential information within character string data.

The term “determination result” refers to data indicating whether at least one offensive expression or confidential information is present in the character string data, and optionally indicating related classification categories.

The term “position information” refers to data describing locations of specific portions of character string data, including at least character indices, token indices, or span boundaries, corresponding to detected offensive expressions or confidential information.

The term “risk level” refers to an evaluation metric associated with detected offensive expressions or confidential information, indicating at least a severity or importance of the detected content for moderation purposes.

The term “detection result data” refers to structured data including at least a determination result, position information, classification labels, and a risk level obtained from analysis of character string data.

The term “prompt sentence” refers to a text sequence generated by the processor that describes instructions, constraints, or context, and is provided as input data to a generative artificial intelligence model to control generation of a response.

The term “warning content” refers to information included in a prompt sentence or a warning message that indicates to a user or to a generative artificial intelligence model that the posting draft may contain offensive expressions or confidential information.

The term “modification policy” refers to a set of rules, guidelines, or transformation objectives encoded in a prompt sentence and used to instruct a generative artificial intelligence model how to alter a posting draft to reduce offensiveness or confidentiality.

The term “generative artificial intelligence model” refers to a machine learning model configured to generate text, including at least a language model that receives a prompt sentence as input and outputs response character string data.

The term “response character string data” refers to generated text output produced by a generative artificial intelligence model in response to a prompt sentence, and serving as a candidate or basis for a modification proposal.

The term “modification proposal” refers to a suggested revision of a posting draft, derived from response character string data, which is intended to reduce at least one of offensiveness and confidentiality while preserving an underlying intent.

The term “problem portions” refers to segments of a posting draft identified as containing, or being associated with, offensive expressions or confidential information according to detection result data.

The term “display position information” refers to information specifying how and where problem portions are located within a posting draft for purposes of rendering visual emphasis on a user terminal.

The term “display control information” refers to data specifying at least one of highlighting style, color, underlining, or other visual attributes used by a user terminal to emphasize problem portions in a posting draft.

The term “presentation information” refers to data transmitted from a server to a user terminal that includes at least a warning message, one or more modification proposals, and related control data for display and user interaction.

The term “warning message” refers to text or equivalent output that indicates to a user a possibility that a posting draft includes offensive expressions or confidential information, and optionally prompts for user action.

The term “acceptance or rejection of the modification proposal” refers to a user's selection, communicated from a user terminal to a server, to either adopt or decline use of a modification proposal suggested for a posting draft.

The term “modified character string data” refers to text obtained by at least one of applying a modification proposal and manual editing by a user, and representing an updated version of a posting draft.

The term “predetermined criterion” refers to at least one rule or threshold used by the processor to decide whether modified character string data is acceptable for posting with respect to offensiveness or confidentiality.

The term “posting permission information” refers to data indicating that modified character string data has satisfied the predetermined criterion and may be transmitted to an information sharing service.

The term “additional warning information” refers to data indicating that modified character string data still contains issues related to offensive expressions or confidential information and that further modification or review is requested.

The term “transmission control information” refers to data used by a server to control sending of modified character string data, including at least a destination specification and a timing condition, to an information sharing service.

The term “information sharing service” refers to a network-accessible platform or system that receives, stores, and distributes user-generated content to multiple recipients, including at least social networking services, messaging services, and online communities.

In one embodiment, a server, a terminal, and a communication network cooperate to implement the claimed system. The server includes at least one processor, a main memory, a non-volatile storage device, and a network interface. The terminal includes at least one processor, a display unit, an input unit, a memory, and a communication interface. The server executes a content safety application that performs natural language processing, dictionary- and pattern-based detection, prompt sentence generation, interaction with a generative AI model, and feedback control of posting to an information sharing service.

The server stores in the non-volatile storage device a program executed by the processor. The program is implemented in a high-level programming language such as a scripting language or a general-purpose language. The server also stores a natural language processing library such as a statistical or neural natural language toolkit and a linguistic resource, for example, a pre-trained language model for tokenization and part-of-speech tagging. The server further stores dictionary information for offensive expressions and confidential information as structured data in a relational database management system or key-value store, and regular expression information representing patterns of confidential information in a configuration repository.

The server uses the natural language processing library to segment character string data, represented as Unicode text, into linguistic units. The server loads a model file of a natural language processing component, such as a word segmentation model and a part-of-speech tagger model trained on a corpus of user-generated texts. The natural language processing component internally uses a neural sequence tagging architecture, for example a bidirectional recurrent neural network or a transformer-based encoder, with learned embeddings for characters and words. The server uses this component to convert character sequences into token indices and to attach syntactic and semantic tags to each token. By using this structured representation, the server reduces the complexity of later dictionary and pattern matching operations, because the server aligns dictionary entries and regular expression patterns to token boundaries rather than raw byte offsets. This improves both processing speed and detection accuracy.

The server uses the dictionary information to detect offensive expressions and confidential information. The server stores the dictionary information in a normalized table structure in the database, where each vocabulary entry is associated with classification labels and a risk level value. The server loads the dictionary into memory as hash maps keyed by normalized token strings and n-grams. The server normalizes tokens by lowercasing, removing diacritics, and optionally applying lemmatization to map inflected forms to base forms. The server then performs lookups using constant-time hash operations for each token and each n-gram sequence. In addition, the server applies regular expressions to the original character string data to detect structured confidential patterns such as telephone numbers and financial account numbers. The server uses a compiled regular expression engine to minimize backtracking and to ensure deterministic execution time.

The server integrates the dictionary and pattern matching results into detection result data. The detection result data is stored in a structured data object held in memory, which includes at least: identifiers of matched dictionary entries, start and end character offsets of each match, token indices corresponding to each match, a classification type such as “offensive” or “confidential”, and a numerical risk level. The server aggregates risk levels for multiple matches by applying a deterministic aggregation rule, such as summation with saturation or maximum selection, to compute an overall risk level for the posting draft. The server also computes density metrics, for example, the ratio of offensive tokens to the total number of tokens and the presence of certain high-risk categories such as explicit slurs or complete financial identifiers. By encoding this information in the detection result data, the server can later adapt the behavior of the generative AI model interaction and the warnings displayed to the user.

The server uses the detection result data to construct a prompt sentence for a generative AI model. The generative AI model is, in one embodiment, a transformer-based neural network language model having an encoder-decoder or decoder-only architecture, multiple attention layers, and a parameter count in the order of billions. The model is trained offline on large corpora of diverse texts using a self-supervised language modeling objective, such as minimizing a cross-entropy loss between predicted and actual next tokens. During the training phase, the model parameters, including weight matrices of attention layers and feed-forward networks, are updated using an optimization algorithm such as stochastic gradient descent with adaptive moment estimation. The server does not train the generative AI model during normal operation but interacts with a pre-trained and optionally fine-tuned instance deployed on the same server or on a remote computing node.

The server formulates the prompt sentence as a plain text sequence that explicitly describes the modification policy and the constraints on the output. The server may include in the prompt sentence the original posting draft, a list of detected categories (for example, “offensive”, “confidential”), and explicit instructions for rewriting. For example, the server may generate:
“Rewrite the following social media post to keep the original meaning but remove offensive or aggressive expressions. Use a polite and neutral tone.

Original post: ‘This product is the worst!’”

In another example related to confidential information, the server may generate:
“Rewrite the following text so that any personal or confidential information (phone numbers, credit card numbers, addresses, email addresses) is removed or anonymized, while keeping the main idea.

Original text: ‘My phone number is 090-1234-5678 and my credit card is 1234-5678-9012-3456’″

The server controls the behavior of the generative AI model by encoding within the prompt sentence constraints such as “do not introduce new personal information” and “do not change the factual core of the complaint”. As a result, the generative AI model generates text that minimizes offensive or confidential elements while preserving user intent.

The server transmits the prompt sentence to the generative AI model. When the generative AI model is deployed as a separate process or on a remote node, the server uses a network interface and a communication protocol, such as an HTTP-based application programming interface, to transmit the prompt text and to receive generated text. The server includes in the API call parameters such as maximum output length, temperature controlling randomness of sampling, and top-k or nucleus sampling thresholds. These parameters allow the server to trade off diversity and determinism of generated text against moderation stability. The server receives from the generative AI model a sequence of token identifiers, which is decoded by a tokenizer into response character string data.

The server inspects the response character string data using the same detection mechanism as for the original posting draft. The server re-applies the natural language processing component to the generated text and performs dictionary and regular expression matching. If any offensive expressions or confidential information remain, the server can automatically adjust the prompt sentence by, for example, explicitly instructing the model to avoid particular categories detected in the previous output, and then resend the adjusted prompt.

This closed-loop control is not a mere automation of human review but an algorithmic feedback mechanism between detection and generation modules that reduces residual risk and converges toward compliant text in fewer iterations. This reduces unnecessary network traffic and processor cycles compared to manual iterative editing and resubmission by the user.

The server generates presentation information combining the detection result data and the modification proposal. The presentation information includes the original posting draft, annotations for problem portions, a warning message, and one or more candidate modification proposals. The server encodes problem portions using position information relative to character indices or token indices, allowing the terminal to draw underlines, colored backgrounds, or other highlighting on specific segments. For example, if the user drafts “This product is the worst!”, the server may identify “the worst” as an offensive expression and annotate the corresponding indices. The server generates a warning message such as “There is a possibility that this may be perceived as offensive. Do you still want to send it?” and attaches the generated alternative “This product did not work well for me.” as a modification proposal.

The terminal receives the presentation information and executes display control based on the included display control information. The terminal highlights the problem portions on the display unit, shows the warning message in a dialog or banner, and presents the candidate modification proposal in a separate field. The user can select an operation, such as accepting the modification proposal, editing the proposal further, or rejecting the proposal. When the user edits text, the terminal locally updates the character string data and sends the modified character string data back to the server for re-analysis. This architecture keeps the computationally intensive natural language processing and generative operations concentrated on the server side, thereby reducing the hardware requirements on the terminal while still allowing interactive feedback in real time.

The server determines whether modified character string data satisfies a predetermined criterion by re-executing the detection pipeline. The predetermined criterion may include thresholds on the aggregated risk level, absence of certain high-risk categories, and compliance with platform-specific policies. When the criterion is satisfied, the server generates posting permission information, which the server uses to prepare transmission control information for the information sharing service. The server then transmits the modified character string data along with necessary metadata, such as user identifiers and timestamps, to the information sharing service. When the criterion is not satisfied, the server generates additional warning information and may again invoke the generative AI model with an adjusted prompt sentence.

This configuration provides several technical effects. Because the server uses a structured natural language processing pipeline, dictionary-based detection, and pattern-based detection on pre-tokenized units, the server reduces computational redundancy and accelerates detection compared to naive scanning of raw character strings. By using hash-based lookups for vocabulary entries and compiled regular expressions, the server reduces detection latency, which allows the system to scale to high request volumes. The generation of prompt sentences that explicitly encode risk types and modification policies allows the generative AI model to generate more targeted and compliant text, which reduces the number of iterations required to achieve acceptable output, thereby improving computational efficiency and reducing network traffic.

Furthermore, the server's use of detection result data to dynamically adapt prompt sentences—for example, by increasing strictness when high-risk content is detected or by specifying categories to avoid—constitutes a non-conventional orchestration of detection and generation components. This is not a simple automation of human review, because the server uses machine-readable risk metrics, token-level annotations, and structured instructions inside the prompt sentence to control a high-dimensional generative process in a way that would not be feasible manually at similar scale and speed.

In another embodiment, the server implements a variant generative AI model architecture.

For example, the model may be a sequence-to-sequence transformer with an encoder conditioned on the original text and a decoder that outputs the modified text. During training, pairs of original and moderated texts are used, and the model is optimized using a loss function combining cross-entropy loss and an auxiliary penalty encouraging neutral sentiment or removal of confidential patterns. The server may store a moderation-specific fine-tuned model, distinct from a general-purpose language model, and select between models based on language or content type. In yet another embodiment, the server maintains a cache of prompt-response pairs and reuses previous responses for identical or similar drafts, which reduces inference load on the generative AI model and further improves latency.

In still another embodiment, the server uses a rule-based pre-filter in combination with the generative AI model. For example, for low-risk drafts with only mild offensive language, the server may first attempt a deterministic template-based replacement, such as replacing specific offensive adjectives with neutral adjectives, without invoking the generative AI model. For higher-risk drafts or when rule-based correction fails to meet the predetermined criterion, the server escalates to the generative AI model. This hierarchical strategy allows the server to reduce computational costs and response time while maintaining a high level of safety and precision.

The described system improves computer technology by optimizing how natural language content is analyzed, transformed, and validated within a computer network. The server's integrated architecture, including the structured detection result data, dynamic prompt sentence generation, feedback-based interaction with a generative AI model, and token-level highlighting for the terminal, enables faster and more accurate moderation processing than conventional systems that rely on single-pass filters or manual review. These technical improvements manifest in reduced processing latency, lower false positive and false negative rates, reduced network bandwidth for repeated submissions, and more efficient use of computational resources on the server and the terminal.

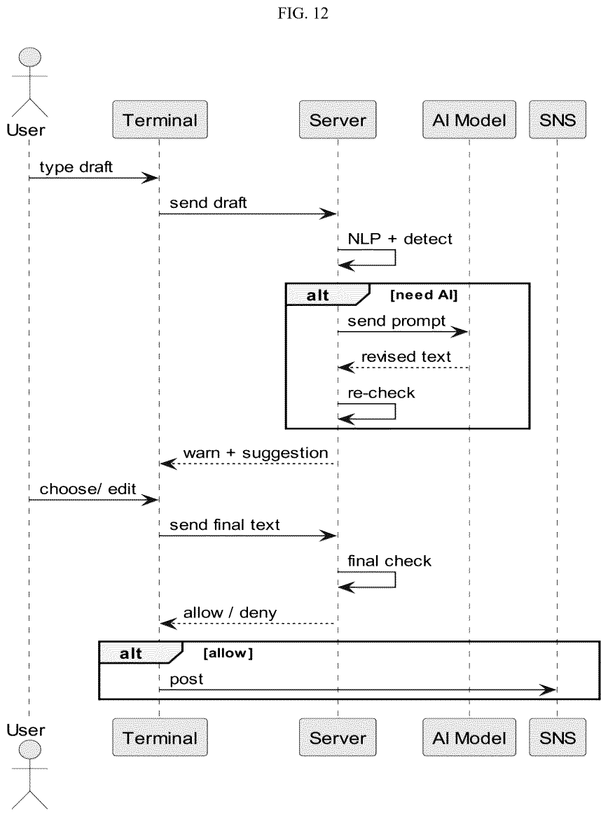

The following describes the processing flow using FIG. 12.

### Step 1:

User creates a posting draft on the terminal.

User operates the terminal and inputs a text draft into a text input field, for example, “This product is the worst!”.

Input: Keyboard or touch input events on the terminal's user interface.

Output: A character string stored in a local buffer on the terminal representing the posting draft.

Terminal aggregates the input events into a complete character string, temporarily stores the string in memory, and associates it with metadata such as language setting and draft identifier.

### Step 2:

Terminal sends the posting draft to the server.

Terminal constructs a request message that includes the character string data and optional metadata (for example, language code and user identifier) and transmits the message through a communication interface over a network to the server.

Input: The locally stored character string and associated metadata.

Output: A network request packet containing the posting draft data delivered to the server.

Terminal formats the data, for example, as a text-based payload, attaches authentication information, and sends it via a network protocol, thereby converting user-entered text into a machine-readable request for server-side processing.

### Step 3:

Server receives the posting draft and performs initial validation.

Server accepts the incoming request through a network interface, parses the payload, and extracts the character string data and metadata.

Input: The network request packet containing the posting draft and metadata.

Output: Validated character string data and a structured internal request object.

Server checks that the payload conforms to expected syntax, verifies authentication tokens, and confirms that the text length and encoding satisfy predefined constraints. Server transforms the raw payload into an internal data structure (for example, an object or record) for downstream processing.

### Step 4:

Server performs natural language preprocessing on the posting draft.

Server applies a natural language processing component to segment the character string data into linguistic units such as tokens, morphemes, and phrases.

Input: The validated character string data.

Output: A tokenized representation including token list, sentence boundaries, and optional linguistic tags.

Server converts the sequence of characters into a sequence of token objects by invoking a segmentation algorithm (for example, a transformer- or recurrent-based tagger). Server assigns token indices, part-of-speech tags, and other annotations, thereby transforming raw text into structured linguistic data suitable for efficient dictionary and pattern matching.

### Step 5:

Server detects offensive expressions and confidential information using dictionary information.

Server compares each token and relevant n-gram sequence in the preprocessed data with dictionary entries stored in memory.

Input: The tokenized representation and in-memory dictionary information.

Output: A set of dictionary matches including matched terms, categories, and positions.

Server normalizes tokens (for example, lowercasing and lemmatization) and performs hash-based lookups in the dictionary maps. Server records, for each match, the matched text, its classification (offensive or confidential), and the corresponding token indices and character offsets, creating intermediate match records.

### Step 6:

Server detects confidential patterns using regular expressions.

Server applies compiled regular expression patterns to the original character string data to identify structured confidential information such as telephone numbers and financial identifiers.

Input: The original character string data and regular expression information.

Output: A set of pattern matches including matched substrings, pattern types, and positions.

Server runs each regular expression against the text using a deterministic matching engine, and for each match, server generates a record specifying the start and end offsets, the detected type (for example, “phone_number”), and an associated risk label.

### Step 7:

Server aggregates detection results and computes a risk level.

Server integrates dictionary-based matches and regular expression-based matches into unified detection result data.

Input: The set of dictionary match records and the set of regular expression match records.

Output: Detection result data including a list of problem portions, overall determination result, and a numerical risk level.

Server merges overlapping or adjacent matches, assigns per-segment risk scores based on classification type and severity, and applies an aggregation function (for example, summation with capping or maximum value) to compute an overall risk level. Server encodes these results in a structured data object that includes determination flags (offensive present, confidential present) and detailed position information.

### Step 8:

Server determines whether generation of a modification proposal is required.

Server evaluates the detection result data to decide whether the posting draft requires modification.

Input: Detection result data containing flags and risk level.

Output: A decision flag indicating whether to issue a warning only or to also request a modification proposal from the generative AI model.

Server compares the risk level and types of detected content to predefined thresholds and rules. If no issues are detected, server sets a “safe” flag; if minor issues are detected, server may choose warning-only; if higher-risk issues are detected, server sets a flag to invoke the generative AI model for modification.

### Step 9:

Server constructs a prompt sentence for the generative AI model.

Server generates a plain-text prompt sentence that encodes the modification policy, warning content, and constraints for the generative AI model.

Input: The original character string data and detection result data (types and positions of problematic content).

Output: A prompt sentence tailored to the detected issues.

Server assembles a multi-line text that includes the original text and explicit instructions. For example, when offensive content is detected, server generates:
“Rewrite the following social media post to keep the original meaning but remove offensive or aggressive expressions. Use a polite and neutral tone.

Original post: ‘This product is the worst!’”

When confidential content is detected, server generates:
“Rewrite the following text so that any personal or confidential information (phone numbers, credit card numbers, addresses, email addresses) is removed or anonymized, while keeping the main idea.

Original text: ‘My phone number is 090-1234-5678 and my credit card is 1234-5678-9012-3456.”?’

In generating the prompt sentence, server inserts markers reflecting which categories (offensive, confidential) were detected and may adjust tone and strictness parameters encoded as textual instructions.

### Step 10:

Server sends the prompt sentence to the generative AI model and obtains a response.

Server transmits the prompt sentence to a generative AI model implemented as a transformer-based neural network and receives generated response character string data.

Input: The prompt sentence and generation parameters (for example, maximum length and temperature).

Output: Response character string data serving as a candidate modification proposal.

Server encodes the prompt into the input format required by the model, invokes a text generation process on the model, and decodes the returned token sequence into a human-readable string. Server thus transforms the instruction-enriched prompt into a proposed revised text that is expected to have reduced offensiveness or confidentiality.

### Step 11:

Server re-analyzes the response character string data for residual problems.

Server applies the same natural language preprocessing, dictionary matching, and pattern matching operations to the generated text.

Input: The response character string data from the generative AI model.

Output: Secondary detection result data for the generated text and a validation flag indicating acceptability.

Server tokenizes the generated text, looks up tokens in the dictionary, and re-applies regular expressions. Server then aggregates matches into detection result data and evaluates whether any offensive expressions or confidential information remain. If residual issues are found, server may set a flag to regenerate a stricter prompt or mark the proposal as needing further processing.

### Step 12:

Server selects and finalizes a modification proposal.

Server decides whether to accept the current generated text as a modification proposal or to attempt further refinement.

Input: Secondary detection result data and the response character string data.

Output: A finalized modification proposal string or a decision to generate another proposal.

Server inspects the validation flag; if the generated text satisfies the predetermined criterion (for example, no high-risk matches and risk below threshold), server adopts it as a modification proposal. If not, server may modify the prompt sentence to include stricter constraints and repeat interaction with the generative AI model until acceptable output is obtained or a maximum iteration count is reached.

### Step 13:

Server generates presentation information for the terminal.

Server composes a data structure that includes problem annotations, a warning message, and the finalized modification proposal.

Input: Original detection result data, the original posting draft, and the finalized modification proposal (if any).

Output: Presentation information containing display control information, a warning message, and one or more modification proposals.

Server converts problem positions into display position information (for example, character index ranges), assigns visual styles for highlighting, and generates a warning message such as “There is a possibility that this may be perceived as offensive. Do you still want to send it?”.

Server bundles these elements with the modification proposal text, ready to be sent to the terminal.

### Step 14:

Server transmits the presentation information to the terminal.

Server sends the composed presentation information via the network interface to the terminal.

Input: The presentation information prepared by the server.

Output: A response message delivered to the terminal containing highlighting data, warning text, and any proposed revisions.

Server serializes the structure into a transport format and dispatches it as a network response, thereby converting internal data structures into a wire format that the terminal can interpret for display.

### Step 15:

Terminal displays the warning and modification proposal to the user.

Terminal receives the presentation information, decodes it, and controls the display unit to visualize problem portions and suggestions.

Input: The response message from the server containing presentation information.

Output: A rendered user interface showing the original draft with highlights, a warning message, and the modification proposal.

Terminal maps display position information to character positions in its text widget, applies highlighting (for example, red underline), and renders the warning as a dialog or banner.

Terminal displays the modification proposal in a selectable area, allowing the user to preview and choose it.

### Step 16:

User reviews the information and selects an action.

User inspects the highlighted draft, reads the warning message, and compares the original text with the modification proposal.

Input: The visual presentation of the original draft, warning, and modification proposal on the terminal.

Output: A user action such as accepting, editing, or rejecting the modification proposal.

User may tap a button to replace the draft with the proposal, manually edit text in the input field, or continue with the original text. The chosen action is converted by the terminal into a state update for the character string data and into control signals for subsequent communication with the server.

### Step 17:

Terminal sends modified character string data or user decision back to the server.

Terminal constructs a follow-up request communicating either an accepted modification proposal, a user-edited draft, or a decision to post without changes.

Input: The updated character string data and the selected user action.

Output: A follow-up network request containing modified character string data and action type.

Terminal includes the new text and flags indicating the context (for example, “post-check” or “final submission”) and transmits this data to the server for re-analysis or posting authorization.

### Step 18:

Server re-checks the modified character string data against the predetermined criterion.

Server repeats the natural language preprocessing and detection pipeline for the modified text and evaluates compliance.

Input: The modified character string data and context flags from the terminal.

Output: A final detection result and a decision to grant or deny posting permission.

Server tokenizes and analyzes the modified text, aggregates matches, computes a risk level, and compares it with thresholds defined by the platform policy. Server sets a posting permission flag when the criterion is satisfied, or generates additional warning information when issues remain.

### Step 19:

Server generates posting permission or additional warning information.

Server prepares data indicating whether the modified draft is allowed to be posted.

Input: The final detection result and decision flag.

Output: Either posting permission information or additional warning information.

Server transforms the decision into a structured response, including a simple approval status and, if necessary, an additional warning message. This response is then forwarded to the terminal to control the next user-visible action.

### Step 20:

Terminal posts the approved content to the information sharing service or displays additional warnings.

Terminal receives the server's final decision and performs the corresponding action.

Input: The posting permission information or additional warning information received from the server.

Output: In the case of permission, a request to the information sharing service containing the approved text; in the case of denial, an updated user interface showing further warning.

When posting is permitted, terminal sends the approved character string data to the information sharing service using its communication interface, thereby causing the content to be stored and distributed. When posting is not permitted, terminal displays the additional warning and may re-enter the cycle of modification and re-checking.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional content moderation systems in information sharing services largely rely on static keyword filtering, simple rule-based classification, or coarse machine learning models that treat text as a bag of words without robust contextual understanding. Such systems frequently suffer from high false-positive and false-negative rates when detecting offensive or confidential content. As a result, benign posts are unnecessarily blocked, while genuinely harmful or sensitive posts are sometimes allowed to be published. This degrades user experience, undermines trust in the platform, and fails to provide technically reliable protection against unintentional disclosure or harmful communication.

Furthermore, in many existing systems, the moderation pipeline is architected as a rigid, monolithic component that does not exploit modern generative AI models through structured prompt sentences, nor does it produce machine-readable, explanation-rich evaluation data (for example, explicit flags and reasons) that can be programmatically consumed by downstream logic. This architectural limitation prevents fine-grained, dynamic control over warning messages and follow-on actions, such as interactive correction proposals.

In addition, traditional user warning mechanisms often present generic, static alerts that are not tailored to the specific risk inferred from the content or to the emotional state of the user. These generic alerts can lead to “warning fatigue,” where users ignore or mechanically dismiss warnings. Existing systems also rarely provide automated modification proposals that concretely reduce offensiveness or confidentiality in a user's draft, thereby forcing users to manually guess how to revise their content. This results in inefficient user workflows and increases the likelihood that risky content will be posted unchanged.

From a computer-technology perspective, there is a need for an improved server-side architecture and processing pipeline that: (i) transforms user post data into normalized text; (ii) constructs structured prompt sentences for a generative AI model; (iii) receives and parses machine-readable evaluation result data including explicit determination flags and reasons; (iv) integrates an emotion analysis processing unit to dynamically adjust the warning messages generated server-side; and (v) generates, via further prompt sentences, modification proposals that programmatically reduce offensiveness or confidentiality. Such an architecture would improve the technical functioning of the content moderation subsystem by enabling more accurate risk detection, more intelligent interaction with users, and more effective prevention of harmful or confidential disclosures, while still enabling efficient posting workflows.

The specific processing by the specific processing unit 290 of the data processing device 12 in Example 2 is realized by the following means.

The present invention provides a server comprising a processor configured to acquire post information transmitted from a terminal in an information sharing service, normalize a character string of the post information to obtain normalized text, generate a prompt sentence including the normalized text as input information to a generative AI model, transmit evaluation request data including the prompt sentence to the generative AI model, acquire evaluation result data in a machine-readable format from the generative AI model indicating presence or absence of offensive content or confidential content and a reason related to the evaluation, parse the evaluation result data to generate at least one determination flag, determine, based on the at least one determination flag, a necessity and a type of a warning message, generate in accordance with a determination result a warning message indicating at least one of a possibility of offensive content or a possibility of confidential content, transmit the warning message and the post information to the terminal to cause the terminal to display the warning message as an interactive screen, acquire from the terminal response information including a selection result of a user regarding continuation or cancellation of posting, record the post information in a publication storage region of the information sharing service when the selection result indicates continuation of posting, control so as not to record the post information when the selection result indicates cancellation of posting, obtain analysis result information regarding an emotional state of the user by using an emotion analysis processing unit, adjust expression content or intensity of the warning message based on at least one of the analysis result information and the evaluation result data, and, when the selection result indicates continuation of posting and the at least one determination flag indicates presence of at least one of offensive content or confidential content, generate a correction prompt sentence that instructs the generative AI model to generate modification proposal data that reduces offensiveness or confidentiality of the post information, transmit the correction prompt sentence to the generative AI model, acquire the modification proposal data, and transmit the modification proposal data to the terminal for presentation. This enables an improved computer-implemented moderation pipeline that leverages generative AI models via structured prompt sentences and machine-readable evaluation data, dynamically adapts warning messages based on user emotional state, and automatically produces concrete modification proposals, thereby technically enhancing accuracy, efficiency, and user interaction within the content posting process.

The term “information sharing service” refers to an electronic communication environment implemented on one or more computer systems, in which multiple users are able to create, transmit, view, and store digital content such as text, images, audio, or video, and in which such content can be made accessible to other users via a network.

The term “terminal” refers to an electronic device operated by a user, including but not limited to a smartphone, tablet, notebook computer, desktop computer, or other computing device, that executes a client application or browser and is capable of transmitting and receiving data with a server over a network.

The term “post information” refers to digital data representing content that a user intends to submit to an information sharing service, the digital data including at least a text portion and optionally including associated metadata such as a user identifier, a timestamp, or a content identifier.

The term “processor” refers to one or more hardware processing units, such as central processing units, graphics processing units, or other programmable data processing circuitry, configured to execute instructions and to perform arithmetic, logic, control, and input/output operations.

The term “natural language processing” refers to a class of computational techniques and algorithms executed by a processor for analyzing, interpreting, generating, or transforming human language text, including tasks such as tokenization, part-of-speech tagging, syntactic parsing, semantic analysis, and classification.

The term “normalized text” refers to a representation of a character string that has been transformed according to one or more text preprocessing operations, including but not limited to trimming whitespace, unifying character encodings, normalizing line breaks, and converting characters or symbols to a standardized form, in order to facilitate subsequent computational processing.

The term “prompt sentence” refers to a machine-readable text sequence that encodes an instruction, a query, or a task description together with associated data, and that is provided as input to a generative AI model to cause the generative AI model to perform a specified processing operation.

The term “generative AI model” refers to a computer-implemented model based on machine learning, such as a neural network language model, that is trained on data and configured to generate or transform natural language or other forms of content in response to an input prompt.

The term “evaluation request data” refers to digital data transmitted from a server to a generative AI model, the digital data including at least one prompt sentence and optionally additional parameters, and being structured to cause the generative AI model to generate an evaluation of post information.

The term “evaluation result data” refers to digital data generated by a generative AI model in response to evaluation request data, the digital data including at least information indicating presence or absence of offensive content or confidential content in post information and optionally including a textual or structured explanation of the evaluation.

The term “machine-readable format” refers to a data representation, such as a structured text format or binary format, that is suitable for programmatic parsing and processing by a computer program without requiring human interpretation, including but not limited to formats such as JavaScript Object Notation or extensible markup formats.

The term “determination flag” refers to a data element having a discrete value, such as a Boolean value or an enumerated value, that indicates a classification result for a specific property of post information, including but not limited to whether the post information includes offensive content or confidential content.

The term “warning message” refers to a natural language or symbolic message generated by a server and provided to a terminal for display to a user, the message indicating that post information may include offensive content or confidential content and prompting the user to select whether to continue or cancel posting.

The term “interactive screen” refers to a user interface presentation on a terminal that displays information, such as a warning message, and includes one or more input controls, such as buttons or links, that receive user selections or commands in response to the displayed information.

The term “response information” refers to digital data transmitted from a terminal to a server that encodes a user's selection or input in response to an interactive screen, including at least an indication of whether the user chooses to continue posting or cancel posting.

The term “publication storage region” refers to a logical or physical storage area managed by an information sharing service, in which post information that has been approved for publication is persistently stored and from which the post information can be retrieved for display to other users.

The term “emotion analysis processing unit” refers to a software-implemented or hardware-accelerated component configured to process user-related data, such as text, audio, or interaction patterns, and to generate analysis result information indicating an estimated emotional state of the user, such as anger, sadness, or neutrality.

The term “analysis result information regarding an emotional state” refers to digital data generated by an emotion analysis processing unit that encodes one or more indicators of a user's emotional condition, including but not limited to scores, labels, or categories corresponding to emotional states.

The term “expression content or intensity of the warning message” refers to linguistic and presentation characteristics of a warning message, including but not limited to word choice, sentence structure, politeness level, emphasis, or urgency, which can be adjusted to change how strongly the warning is communicated to the user.

The term “correction prompt sentence” refers to a prompt sentence specifically configured to instruct a generative AI model to generate modification proposal data that changes post information so as to reduce offensiveness or confidentiality while preserving intended meaning where possible.

The term “modification proposal data” refers to digital data generated by a generative AI model in response to a correction prompt sentence, the digital data including at least one alternative version of post information that has reduced offensiveness or confidentiality in comparison to the original post information.

The term “offensive content” refers to content that is likely to be perceived as insulting, abusive, harassing, or otherwise harmful to individuals or groups, based on linguistic analysis, context, or applicable policies defined by an information sharing service.

The term “confidential content” refers to content that is likely to include non-public, sensitive, or restricted information, such as trade secrets, internal business information, personal identifiable information, or other data that should not be disclosed to unauthorized parties.

The term “selection result” refers to a value contained in response information that indicates a user's choice among available options on an interactive screen, including at least a choice between continuation of posting and cancellation of posting.

In one embodiment, a server implements the claimed system as a network-accessible backend executing on general-purpose computing hardware. The server includes at least one multi-core central processing unit, a main memory, a non-volatile storage device, and a network interface controller connected to a packet-based communication network. The server executes an operating system such as a general-purpose server operating system and application software including a web application framework, an HTTP server, and a machine learning inference framework. The server communicates with a terminal operated by a user over a secure transport protocol. The terminal includes a display, an input device such as a keyboard or touch panel, a local processor, and a local memory, and executes a client program such as a web browser or a native application.

The server executes a content moderation program that implements a series of specialized modules: an input acquisition module, a text normalization module, a prompt generation module, a generative AI interface module, an evaluation parsing module, a decision logic module, a warning generation module, an emotion analysis module, a correction prompt generation module, and a publication control module. These modules are realized as software components running on the server processor and operating on in-memory data structures. The data structures include at least a post information object, an evaluation request object, an evaluation result object, a determination flag set, a warning message object, and a modification proposal object.

The server acquires post information from the terminal as a structured data object. The post information includes at least a text field containing a user-authored message and may optionally include metadata such as a user identifier and a tentative post identifier. The server stores the received post information in a volatile memory region and assigns internal identifiers to the post information for subsequent processing. The server then invokes the text normalization module.

The server, by the text normalization module, performs character-level and token-level normalization on the text field of the post information. The server applies normalization operations such as trimming leading and trailing whitespace, converting different line break sequences to a single canonical representation, mapping variant Unicode sequences to a canonical normalization form, and resolving commonly used typographical variants. In some embodiments, the server further performs tokenization and lowercasing where appropriate for the language of the input, while preserving information, such as original casing flags, in a separate feature structure. By performing this normalization on the server, the system reduces variability in the input to the generative AI model, which improves computational efficiency and reduces misclassification due to superficial formatting differences.

The server constructs a prompt sentence intended for a generative AI model. The server maintains a prompt template in a configuration storage region. The template is a natural language instruction that specifies the evaluation task, the expected output format, and the text to be evaluated. For example, the server may construct the following prompt sentence:
“Analyze the following user post and determine whether it is offensive or contains confidential information. Return the result as a JSON-like description with fields ‘offensive’ (true or false), ‘confidential’ (true or false), and ‘reason’ (short explanation). User post: ‘This information is strictly confidential, but I will share it with others outside the organization.’” In another example, the server may construct a prompt sentence:
“Please determine whether the following text is offensive or contains confidential information. Explain briefly why. Text: ‘I will share our company's secret client list publicly.’”

The server inserts the normalized text into the template, producing a complete prompt sentence. The server stores the prompt sentence in a dedicated prompt buffer associated with the current post information.

The server then generates evaluation request data for the generative AI model. In one embodiment, the generative AI model is a neural network-based language model implemented on a separate inference server, such as a transformer-based architecture having multiple self-attention layers, feed-forward layers, and layer normalization components. The generative AI model is trained in advance on large-scale text corpora using an autoregressive language modeling objective that minimizes a cross-entropy loss between predicted token distributions and ground-truth tokens. During training, the model parameters are updated using a gradient-based optimization algorithm, such as stochastic gradient descent or an adaptive variant, to reduce the loss over many iterations. Additional fine-tuning may be performed on curated datasets labeled for offensiveness, confidentiality, and content safety, so that the model learns internal representations that correlate with content safety dimensions.

The server, in some embodiments, invokes the generative AI model through a machine learning framework executing locally, such as a deep learning framework running on central processing units or graphics processing units. In other embodiments, the server accesses the generative AI model over a network interface as a remote service. In either case, the server converts the prompt sentence into an internal token sequence using a tokenizer compatible with the model, and generates attention masks and sequence length parameters. The server then supplies these inputs to the inference engine.

The generative AI model internally processes the prompt sentence using its transformer architecture. The model computes token embeddings, applies multiple layers of multi-head self-attention, and propagates intermediate representations through position-wise feed-forward networks. The attention mechanism computes weighted sums of representations based on learned query, key, and value matrices, enabling the model to capture contextual relationships across the entire prompt sentence. The final hidden states feed into a prediction head that generates an output token sequence. Because the prompt sentence instructs the model to output a machine-readable description containing fields such as “offensive,” “confidential,” and “reason,” the model's learned parameters generate an output sequence that encodes these fields in a stable, parseable pattern.

By structuring the evaluation as a prompt sentence to a transformer-based generative AI model, the system leverages high-dimensional contextual representations of human language, which exceed the capabilities of traditional keyword-based filters or shallow classifiers. The model can distinguish statements such as “This is a secret” used metaphorically from statements that actually reference confidential business plans, by learning patterns from training data. This results in improved detection accuracy and reduced false positives.

The server receives evaluation result data from the generative AI model. The evaluation result data includes at least the fields “offensive,” “confidential,” and “reason” represented as a sequence of characters. The server parses this sequence using a machine-readable parsing routine. For example, if the output has the form:
“{offensive: false, confidential: true, reason: The text indicates sharing of confidential internal information.}”
the server applies a pattern-matching function to extract values for each field. The server maps the textual values “true” and “false” to internal Boolean flags and stores these flags in a determination flag set associated with the post information.

The server, by the decision logic module, applies rule-based logic to the determination flag set. The server classifies a case where both offensive and confidential flags are false as a low-risk case, a case where only one of the flags is true as a medium-risk case, and a case where both flags are true as a high-risk case. The server uses this classification to decide whether a warning message is necessary and which warning type should be generated. This decision is performed programmatically and deterministically based on the parsed output of the generative AI model.

The server constructs a warning message based on the determination flag set. When the offensive flag is true and the confidential flag is false, the server generates a warning message such as:
“This post may be perceived as offensive. Do you still want to post it?”

When the offensive flag is false and the confidential flag is true, the server generates a warning message such as:
“This post may contain confidential information. Do you still want to post it?”

When both flags are true, the server may generate a combined warning message, such as:
“This post may be perceived as offensive and may contain confidential information. Do you still want to post it?”

The server packages the warning message together with the post information and transmits them to the terminal via the network interface. The terminal receives the warning message and displays it as an interactive screen, such as a modal dialog, where the user can select between continuing the post or canceling the post. The interactive screen uses a graphical user interface component that prevents further posting actions until the user provides input. The server also incorporates an emotion analysis processing unit. In one implementation, the server acquires emotion-related data, such as recent text posts, message history, or other interaction signals associated with the user, and processes the data using an emotion classification model. The emotion classification model can be implemented as a neural network configured to output probabilities for categories such as anger, frustration, or calmness. This model may also be a transformer-based classifier fine-tuned on datasets annotated with emotional labels, using a loss function, such as categorical cross-entropy, and a training process similar to that of the generative AI model. The server receives an analysis result, such as an estimated anger score, and uses this to adjust the expression content or intensity of the warning message. For example, if the anger score exceeds a predetermined threshold, the server may select a more cautious and de-escalating wording in the warning message, or may increase the prominence of the warning by adding more explicit guidance. By dynamically tailoring the warning message based on both the generative AI model's evaluation result and the emotional state of the user, the server achieves a technical improvement in the user interface behavior. The server can modulate the warning's tone and strength so as to reduce the likelihood that an emotionally charged user will ignore an important warning. This dynamic adaptation is implemented through explicit computation over digital signals (emotional analysis outputs and classification flags), not through human discretion, thereby constituting a specific improvement in the computer system's management of user interaction and error prevention.

When the terminal transmits response information indicating that the user chooses to continue posting, and when the determination flag set indicates the presence of offensive content or confidential content, the server constructs a correction prompt sentence. The correction prompt sentence instructs the generative AI model to propose a modified version of the post information that reduces offensiveness or confidentiality while preserving the intended meaning. An example correction prompt sentence is:
“Rewrite the following user post so that it is polite and does not reveal confidential information, while preserving the original intent as much as possible. Provide only the revised text. User post: ‘This information is strictly confidential, but I will share it with others outside the organization.’”

Another example of a correction prompt sentence is:
“Please provide a revised version of the following text that removes any offensive expressions and avoids disclosing internal business details. Revised text should remain clear and professional. Text: ‘I hate my coworker and I'm going to leak our internal financial report.’”

The server generates the correction prompt sentence by inserting the post information text into a correction template. The server may optionally incorporate the user's emotional state into the prompt sentence, for example by requesting a calmer tone if the user is estimated to be angry. The server then submits the correction prompt sentence to the same or a different generative AI model configured for text rewriting.

The generative AI model processes the correction prompt sentence similarly through its transformer architecture and generates a modification proposal. For instance, given the above example, the model might output:
“I am dissatisfied with the situation, and I would like to discuss our concerns about the financial report internally rather than sharing it externally.”

The server receives the modification proposal data and stores it in association with the post information. The server transmits the modification proposal data to the terminal, where the terminal displays the proposed alternative as a candidate replacement for the original text.

The user may accept the proposed modification, edit it further, or discard it. By providing this proposal, the server enables a processing pathway where risky content is automatically transformed into safer content using learned transformation rules encoded in the generative AI model's parameters, rather than merely blocking or allowing content.

This specific architecture yields several technical effects. First, the use of normalized text and a stable prompt sentence reduces the input variance presented to the generative AI model, which in turn reduces tokenization overhead and improves the consistency of the model's outputs, resulting in lower parsing errors and reduced need for fallback checks. Second, the parsing of evaluation result data into determination flags allows the server to perform low-complexity, deterministic control logic in constant time, which reduces CPU utilization as compared to repeatedly running complex semantic checks on the raw text. Third, by using a generative AI model with a transformer architecture trained for content safety, the system can detect nuanced offensive or confidential content that traditional rule-based systems miss, thereby reducing false negatives and improving safety. Fourth, the correction prompt sentence mechanism enables automatic generation of safer variants, reducing the number of user editing cycles and the volume of repeated network requests, thus reducing overall communication load and latency.

Moreover, the integration of emotion analysis results into the warning generation process improves the management of user attention and reduces the probability that a user in a highly emotional state will ignore warnings. This interaction-level adaptation is computed automatically by the server and forms part of the control logic for the user interface behavior, improving the technical operation of the human-computer interface.

In alternative embodiments, the server may host the generative AI model locally on a graphics processing unit array, allowing low-latency inference for high-throughput environments. In such embodiments, the server uses the machine learning framework's runtime to pre-load model weights into GPU memory and to batch multiple prompt sentences, thus improving the throughput and reducing per-request overhead. In another variation, the server may maintain multiple generative AI models specialized for different languages, and use a language identification submodule to route prompt sentences to an appropriate model. This routing reduces misclassification due to language mismatch and further improves accuracy.

In another embodiment, the server may store historical evaluation result data and determination flags in a log structure, and periodically retrain or fine-tune the generative AI model on cases where the system's decisions were manually overridden by administrators. This feedback loop allows the model's parameters to be updated using supervised learning with a loss function that penalizes divergence from administrator-corrected labels, resulting in gradual improvement of detection performance. The server thus not only executes current inferences but also participates in an ongoing optimization of its own classification component.

The terminal, in all embodiments, serves as a presentation and input device and does not perform heavy natural language processing. The server centralizes the computationally intensive parts, such as tokenization, transformer inference, parsing, and decision logic, leveraging dedicated computing resources. The user interacts with the system through the terminal, but the evaluation logic remains within the server, ensuring consistent behavior across different terminal types.

Through these detailed arrangements of hardware, software modules, data structures, and neural network configurations, the system implements more than a mere abstract idea of “reviewing posts.” The server performs specific machine-implemented transformations on digital text, uses specialized neural architectures and training regimes for content safety, and orchestrates a structured data flow from post acquisition to normalized text, prompt sentence generation, generative evaluation, deterministic flag derivation, adaptive warning generation, and automated modification proposal generation. These technical operations collectively yield improved accuracy, reduced latency, and enhanced robustness in content moderation, thereby improving the functioning of the computer system itself.

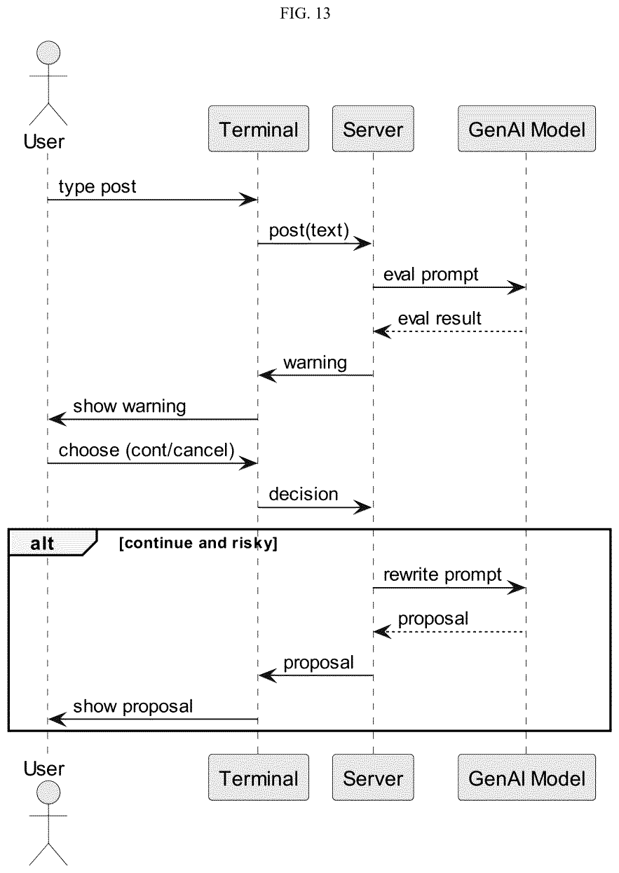

The following describes the processing flow using FIG. 13.

### Step 1:

The user inputs post text on the terminal.

The user operates a keyboard or touch panel of the terminal to enter a message in a text input field of a client application.

Input: Physical keystrokes or touch events.

Output: A text string stored in a UI text buffer of the terminal.

### Step 2:

The terminal constructs a post information object.

The terminal reads the text buffer, associates it with metadata such as a user identifier and a tentative post identifier, and forms a structured object (for example, a key-value structure).

Input: The text string from the UI text buffer and local user/session metadata.

Output: A post information object containing at least a text field and a user identifier.

### Step 3:

The terminal transmits the post information object to the server.

The terminal serializes the post information object into a message format, encapsulates it in a network request, and sends it to a predefined server endpoint over a secure channel.

Input: The post information object.

Output: A network request containing the serialized post information delivered to the server.

### Step 4:

The server receives and parses the post information.

The server accepts the network request via a network interface, extracts the message body, and deserializes it into an internal post information structure.

Input: The serialized post information in the network request.

Output: A server-side post information structure with a text field, user identifier, and internal post identifier.

### Step 5:

The server normalizes the post text.

The server reads the text field from the post information, applies character-level normalization (for example, trimming whitespace, unifying line endings, converting characters to a canonical Unicode form), and may apply token-level normalization such as lowercasing and normalization of punctuation.

Input: The raw text field from the post information structure.

Output: A normalized text string stored in association with the post information.

### Step 6:

The server generates a prompt sentence for the generative AI model.

The server selects a prompt template that specifies the evaluation task (offensiveness and confidentiality detection) and inserts the normalized text into the template using string concatenation.

Input: The normalized text string and a stored prompt template.

Output: A complete prompt sentence ready to be supplied to the generative AI model.

### Step 7:

The server prepares evaluation request data for the generative AI model.

The server converts the prompt sentence into a model input representation, including tokenization into token IDs, creation of attention masks, and configuration of model parameters such as maximum output length and temperature.

Input: The prompt sentence.

Output: An evaluation request object containing token IDs, attention masks, and generation parameters.

### Step 8:

The server invokes the generative AI model to evaluate the post.

The server submits the evaluation request object to a generative AI model implemented as a transformer-based neural network and triggers an inference operation that processes the prompt sentence through multiple attention and feed-forward layers.

Input: The evaluation request object.

Output: An output token sequence or character sequence representing evaluation result data from the generative AI model.

### Step 9:

The server converts the model output into evaluation result data.

The server decodes the output token sequence into a character string, and then applies a parsing routine to extract structured values for fields such as “offensive,” “confidential,” and “reason.”

Input: The output token sequence from the generative AI model.

Output: An evaluation result structure that includes at least an offensive flag, a confidential flag, and an explanatory reason string.

### Step 10:

The server generates determination flags and a risk classification.

The server maps the extracted “offensive” and “confidential” values into Boolean determination flags, and then applies rule-based decision logic to classify the risk level (for example, low, medium, or high) based on combinations of these flags.

Input: The evaluation result structure.

Output: A determination flag set and an associated risk level classification stored with the post information.

### Step 11:

The server decides whether a warning message is required.

The server examines the determination flag set and the risk level and determines if at least one of offensive content or confidential content is present. If so, the server sets a warning-required indicator.

Input: The determination flag set and risk level.

Output: A decision value indicating whether a warning message must be generated and which warning type is appropriate.

### Step 12:

The server computes an emotional state of the user.

The server obtains recent user-related data, such as recent messages or interaction logs, and processes this data through an emotion analysis model that outputs one or more emotional scores (for example, anger or frustration).

Input: User-related data and an emotion analysis model.

Output: Analysis result information indicating the estimated emotional state of the user, stored in association with the current post.

### Step 13:

The server generates a warning message adapted to the risk and emotional state.

The server selects a base warning template corresponding to the determination flags and then adjusts the linguistic intensity or politeness level of the text based on the emotional state scores. The server composes a final warning message string.

Input: The determination flag set, the risk level, and the emotional state analysis result.

Output: A warning message string that indicates the specific risk and has a tone adapted to the user's emotional state.

### Step 14:

The server transmits the warning message and post information to the terminal.

The server packages the warning message, the normalized text, and a post identifier into a response structure and sends it back to the terminal via the network interface.

Input: The warning message string, normalized text, and post identifier.

Output: A network response containing the warning message and post information delivered to the terminal.

### Step 15:

The terminal displays the warning message as an interactive screen.

The terminal receives the server response, parses the data, and renders a graphical dialog that shows the warning message and includes at least two selectable controls, such as “Post anyway” and “Cancel.”

Input: The warning message string and post information from the server response.

Output: A visible interactive screen on the terminal display that enables the user to select a response.

### Step 16:

The user selects whether to continue or cancel the post.

The user reads the warning message on the terminal and activates one of the available controls by touching the screen or clicking, thereby indicating either continuation or cancellation.

Input: The interactive controls displayed on the terminal.

Output: A user selection event indicating “continue” or “cancel.”

### Step 17:

The terminal generates and transmits response information to the server.

The terminal converts the user selection event into a structured response object that includes the post identifier and a selection result field, and transmits this object to a confirmation endpoint on the server.

Input: The user selection event and the post identifier.

Output: A network request containing response information with a decision value.

### Step 18:

The server receives the response information and determines posting control.

The server parses the response information to read the selection result and associates it with the corresponding post information using the post identifier.

Input: The structured response information from the terminal.

Output: A control decision indicating whether to publish the post or to suppress it.

### Step 19:

The server records or discards the post information based on the decision.

If the selection result indicates continuation and no override rules are triggered, the server writes the post information into a publication storage region. If the selection result indicates cancellation, the server refrains from writing the post, or marks it as cancelled.

Input: The control decision and the post information structure.

Output: A stored published post in the publication storage region, or a non-published record state.

### Step 20:

The server determines whether a correction proposal is needed.

If the selection result indicates continuation and the determination flags indicate the presence of offensive or confidential content, the server sets a correction-required indicator and proceeds to generate a correction prompt.

Input: The selection result and the determination flag set.

Output: A decision value indicating that a correction prompt sentence should be generated.

### Step 21:

The server generates a correction prompt sentence for rewriting the post.

The server selects a correction template that instructs rewriting to reduce offensiveness or confidentiality and inserts the original or normalized text into the template, optionally incorporating emotional state information to specify a desired tone.

Input: The post text, the determination flag set, and the emotional state analysis result.

Output: A correction prompt sentence configured for a generative AI model.

### Step 22:

The server prepares correction request data for the generative AI model.

The server tokenizes the correction prompt sentence, constructs attention masks, and configures rewriting-specific parameters such as target length and style constraints.

Input: The correction prompt sentence.

Output: A correction request object suitable for submission to the generative AI model.

### Step 23:

The server invokes the generative AI model to generate a modification proposal.

The server submits the correction request object to the transformer-based generative AI model and initiates inference to produce a revised text sequence that adheres to the rewriting instructions.

Input: The correction request object.

Output: A generated token sequence representing a proposed corrected version of the post.

### Step 24:

The server decodes and stores the modification proposal data.

The server converts the generated token sequence into a human-readable text string, checks that it satisfies basic constraints (for example, non-empty, language-consistent), and stores it as modification proposal data associated with the post identifier.

Input: The generated token sequence from the generative AI model.

Output: A modification proposal text string stored in the server's data structures.

### Step 25:

The server transmits the modification proposal to the terminal.

The server packages the modification proposal text and the original post identifier into a response structure and sends it to the terminal over the network.

Input: The modification proposal text and post identifier.

Output: A network response containing modification proposal data delivered to the terminal.

### Step 26:

The terminal presents the modification proposal to the user.

The terminal receives the modification proposal, parses the response, and displays the proposed revised text in an editable area, allowing the user to accept it as is or further edit it before final posting.

Input: The modification proposal text from the server.

Output: A user interface on the terminal that shows the revised text and allows additional user interaction.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional information-sharing platforms, server-side content moderation typically relies on static rule sets, simple keyword filters, or coarse machine-learning classifiers. Such approaches suffer from several technical limitations at the level of computer processing.

First, conventional servers generally process user-generated text in a single pass, applying fixed thresholds for “offensive” or “confidential” content. The server does not maintain structured internal state that jointly represents linguistic features, content-risk features, and user emotion. As a result, the server cannot adaptively control warning generation, message wording, or rewriting behavior based on a combined evaluation of aggressiveness, confidentiality, and emotional tone. This leads either to over-blocking, which degrades usability, or to under-blocking, which allows harmful content to pass through. From a computing standpoint, the processing pipeline is rigid and does not exploit the representational power of modern generative AI models in a systematic, programmatic way.

Second, existing systems typically use generative AI models, if at all, in an ad hoc manner: a user may directly invoke a text generation service, but the server does not algorithmically synthesize rich prompt sentences from structured analysis results. In particular, the server does not automatically construct prompt sentences that encode: (i) normalized and tokenized linguistic units; (ii) machine-readable aggressiveness determination information and confidentiality determination information; and (iii) emotion state information including emotion type and intensity. Without this structured prompt construction, the generative AI model cannot reliably produce context-appropriate warning messages or correction proposals, and the overall pipeline does not achieve stable, predictable behavior at scale.

Third, server architectures in the prior art do not coordinate user interaction flow with the internal AI-based analysis pipeline. Conventional web servers usually return a simple “allow/deny” flag or a coarse warning, leaving the user interface logic to client-side scripts with minimal feedback from deeper content analysis. The server does not generate, in an integrated manner, screen display information that simultaneously includes the original posting text, a dynamically adjusted warning message, and a machine-generated correction proposal, together with explicit user selection options. This lack of integration prevents the server from closing the loop between automated analysis and user decisions, and inhibits the collection of structured feedback for improving the underlying models and rules.

Fourth, many known solutions treat emotion analysis, if present, as a secondary feature that does not influence the core text-processing pipeline. Such systems may log user sentiment but do not use emotion state information to drive the creation and adjustment of warning messages or to shape the behavior of the generative AI model. Consequently, the computer system does not exploit emotion state information as a control signal for downstream natural-language generation. This results in technically suboptimal control of the generative AI model and a missed opportunity to reduce harmful content while preserving user intent.

Accordingly, there is a need for a computer-implemented system and method in which a server: (i) performs structured preprocessing and multi-dimensional analysis of user posting text information; (ii) encodes aggressiveness determination information, confidentiality determination information, and emotion state information into prompt sentences provided to a generative AI model; (iii) uses the outputs of the generative AI model to generate or adjust warning messages and correction proposals; and (iv) orchestrates a feedback interaction with a user terminal so that the final posting text is determined through an integrated, AI-assisted moderation process. By redesigning the server's processing pipeline in this way, the invention aims to improve the technical functioning of the content-moderation subsystem and the utilization of generative AI models within the server environment.

The specific processing by the specific processing unit 290 of the data processing device 12 in Application Example 2 is realized by the following means.

The present invention provides a server comprising a processor configured to acquire posting text information from a user terminal, normalize and segment the posting text information into a sequence of linguistic units and a sequence of identification-target units, and analyze the sequences using dictionary information and rule information to generate aggressiveness determination information and confidentiality determination information, to input the posting text information into an emotion analysis engine to obtain emotion state information including an emotion type and an emotion intensity and associate the emotion state information with the aggressiveness determination information and the confidentiality determination information, to determine, based on at least one of the aggressiveness determination information and the confidentiality determination information, whether the posting text information is a target for warning and, based on the emotion state information, determine a type and an expression style of warning content and generate a warning message, to construct a prompt sentence for a generative AI model as instruction information including at least a part of the posting text information, the aggressiveness determination information, the confidentiality determination information, and the emotion state information and to cause the generative AI model to generate character information for the warning message or for a correction proposal based on the prompt sentence, to transmit screen display information including the posting text information, the warning message, and user selection options to the user terminal and receive response information including at least one of a posting continuation instruction, a correction adoption instruction, and a re-editing instruction, to, when a correction of posting content is selected, construct a correction-instruction prompt sentence including at least a part of the posting text information, the aggressiveness determination information, the confidentiality determination information, and the emotion state information and cause the generative AI model to generate correction proposal character information to be presented to the user terminal, and to acquire final posting text information from the user terminal, optionally perform a simplified re-analysis, and register the final posting text information in a storage area for an information-sharing service. This enables the server to implement an integrated, computer-controlled moderation pipeline in which structured analysis results and emotion state information are programmatically encoded into prompt sentences, thereby improving control over generative AI model behavior, generating context-appropriate warning messages and correction proposals, reducing harmful or confidential content in posted text, and enhancing the technical performance and reliability of content moderation on the information-sharing platform.

The term “posting text information” refers to character data representing content that a user intends to post to an information-sharing platform, including sentences, phrases, symbols, and metadata necessary for server-side analysis and processing.

The term “user terminal” refers to an information processing apparatus operated by a user, such as a client device including a display unit and an input unit, that transmits posting text information and user responses to a server and receives screen display information from the server.

The term “processor” refers to a hardware execution unit, such as a central processing unit or a processing core, that executes program instructions to perform text analysis, emotion analysis control, prompt construction, communication control, and data registration processing.

The term “normalize” refers to processing that converts input character data into a canonical internal representation, including operations such as case conversion, character encoding unification, removal of extraneous whitespace, and standardization of punctuation and symbols.

The term “segment” refers to processing that divides normalized text into smaller analysis units, such as words, tokens, phrases, or other linguistic units, by applying language-specific rules or models.

The term “linguistic units” refers to minimal text elements used for natural language analysis, such as tokens, lemmas, morphemes, or phrases that are derived from the posting text information by segmentation.

The term “identification-target units” refers to text segments, such as named entities, numeric expressions, or specific phrases, that are candidates for detection of aggressiveness, confidentiality, or emotion and are generated during preprocessing of the posting text information.

The term “dictionary information” refers to structured lexical data stored in a memory, including lists of offensive terms, confidential keywords, named entities, and other domain-specific vocabularies used by the processor to analyze posting text information.

The term “rule information” refers to machine-readable specifications of pattern-matching conditions, scoring rules, thresholds, and logical conditions that the processor applies to linguistic units and identification-target units to determine aggressiveness and confidentiality.

The term “aggressiveness information” refers to attributes or indicators associated with words, phrases, or text segments that suggest offensive, insulting, or hostile content within the posting text information.

The term “confidentiality information” refers to attributes or indicators associated with words, phrases, or text segments that suggest the presence of information that should not be publicly disclosed, such as sensitive personal data, internal project identifiers, or exact financial figures.

The term “aggressiveness determination information” refers to analysis results computed by the processor that indicate whether and to what degree the posting text information includes aggressive content, and may include binary flags, severity scores, and lists of detected aggressive expressions.

The term “confidentiality determination information” refers to analysis results computed by the processor that indicate whether and to what degree the posting text information includes confidential content, and may include binary flags, sensitivity scores, and lists of detected confidential expressions.

The term “emotion analysis engine” refers to a software or service component that receives text as input and outputs emotion-related information, such as emotion categories and intensity scores, by applying sentiment analysis or emotion recognition algorithms.

The term “emotion state information” refers to structured data representing a user's emotional state inferred from posting text information, including at least an emotion type, such as anger or joy, and an emotion intensity value or level.

The term “emotion type” refers to a category label representing a specific kind of emotion, such as anger, sadness, joy, fear, or neutrality, assigned by the emotion analysis engine based on the posting text information.

The term “emotion intensity” refers to a quantitative or qualitative measure of the strength of a detected emotion type, such as a numerical score or a discrete level indicating low, medium, or high intensity.

The term “warning message” refers to text generated by the processor, optionally with assistance from a generative AI model, that alerts a user to potential problems in the posting text information, such as aggressiveness or confidentiality risks, and may ask whether to proceed with posting.

The term “warning content” refers to semantic information conveyed by a warning message, including the type of risk, the degree of risk, and an instruction or query to the user regarding posting behavior.

The term “expression style” refers to linguistic characteristics of a warning message, such as politeness level, directness, length, and tone, which may be adjusted based on emotion state information.

The term “prompt sentence” refers to an instruction text that encodes analysis results and control parameters and is provided to a generative AI model to cause the generative AI model to generate a warning message, a correction proposal, or other output text according to specified requirements.

The term “generative AI model” refers to an artificial intelligence model configured to generate natural language text in response to a prompt sentence, using statistical or neural network based language modeling techniques.

The term “instruction information” refers to data provided to a generative AI model, including a prompt sentence and optional parameters, that specifies what kind of output the generative AI model should produce.

The term “character information for the warning message” refers to the output text string generated by the generative AI model or processor that is used as the content of the warning message presented to the user.

The term “correction proposal character information” refers to text generated by the generative AI model in response to a correction-instruction prompt sentence, the text being a candidate revised version of the posting text information with reduced aggressiveness or confidentiality.

The term “screen display information” refers to structured data transmitted from the server to the user terminal that defines elements to be displayed on a user interface, including the original posting text information, the warning message, correction proposals, and user selection options.

The term “user selection option information” refers to data representing selectable actions presented to a user, such as posting continuation, correction adoption, and re-editing, which the user can choose in response to the warning message.

The term “response information” refers to data transmitted from the user terminal to the server indicating a user's choice among the user selection options and optionally including edited text.

The term “posting continuation instruction” refers to an indication within the response information that the user has chosen to proceed with posting, using either the original posting text information or a selected revision.

The term “correction adoption instruction” refers to an indication within the response information that the user has chosen to adopt a correction proposal character information as the basis for final posting text information.

The term “re-editing instruction” refers to an indication within the response information that the user has chosen to manually edit the posting text information further before final posting.

The term “correction-instruction prompt sentence” refers to a prompt sentence constructed by the processor that instructs the generative AI model to generate a revised version of the posting text information that reduces aggressiveness and confidentiality while maintaining substantive meaning.

The term “final posting text information” refers to the text that is ultimately selected or edited by the user after warnings and correction proposals have been presented and is to be registered by the server for posting on the information-sharing platform.

The term “simplified re-analysis” refers to a reduced-cost analysis process applied by the processor to the final posting text information, using a subset of the full analysis operations, to confirm that no critical aggressiveness or confidentiality issues remain.

The term “information-sharing service storage area” refers to a data storage region managed by the server or by an associated service in which posting records, including the final posting text information, are stored for distribution on an information-sharing platform.

The term “information-sharing platform” refers to a network-based service where multiple users can post, view, and exchange content such as text, images, or other data through their respective user terminals.

The term “target for warning” refers to a status assigned to posting text information by the processor when the aggressiveness determination information or the confidentiality determination information satisfies a predetermined condition requiring a warning message to be presented to the user.

In one embodiment, a server implements the claimed system as a network-connected computing apparatus including at least one processor, a main memory, a non-volatile storage device, and a communication interface. The server operates in conjunction with a plurality of terminals and users connected via a communication network. The server executes program code stored in the non-volatile storage device and loaded into the main memory to realize the functions described in the claims.

The server uses general-purpose hardware such as a multi-core central processing unit and, in certain embodiments, a graphics processing unit or tensor processing unit to accelerate neural network inference. The server runs an operating system such as a server-class operating system and application software implemented, for example, in a procedural or object-oriented programming language. The server uses natural language processing libraries such as spaCy or NLTK, sentiment analysis libraries such as TextBlob, and a generative AI model exposed through an application programming interface. The generative AI model corresponds to a large-scale language model based on a neural network architecture having multiple transformer layers, multi-head self-attention, and learned word and position embeddings.

The server maintains, in the non-volatile storage device, dictionary information including lists of offensive terms, confidential terms, and semantic categories, as well as rule information consisting of pattern definitions, thresholds, and weighting rules expressed, for example, as finite-state patterns or regular expressions. The server stores these resources in structured data formats such as key-value maps and token sequence patterns. The server further stores model configuration parameters such as vocabulary size, embedding dimension, number of attention heads, number of layers, and output temperature settings to control behavior of the generative AI model.

The server implements a preprocessing module that receives posting text information from a terminal and converts the posting text information into a normalized internal representation. The server converts characters to a unified encoding, applies Unicode normalization, standardizes punctuation, and removes redundant whitespace. The server then uses a tokenizer component (for example, provided by spaCy or NLTK) to segment the normalized text into linguistic units, such as tokens and phrases, and to derive identification-target units, such as named entities and numeric expressions. The server stores the resulting units in memory as an array or list of token objects, each token object including fields such as a surface form, a lemma, a part-of-speech tag, and a set of feature flags.

The server implements an aggressiveness and confidentiality analysis module that operates on the token objects. The server compares token sequences against the dictionary information using efficient look-up operations and n-gram matching. The server uses rule information to assign scores to token sequences, for example by adding weights when specific patterns of adjectives and targets are matched or when confidential categories such as internal identifiers and precise amounts are detected. The server aggregates the scores across the entire posting text information to compute aggressiveness determination information and confidentiality determination information, which may be stored as structured records containing, for example, binary flags, numeric scores, and lists of matched token indices. Because the server performs this analysis on a previously normalized and tokenized representation, the server minimizes ambiguity and reduces the computational cost of repeated pattern matching, thereby improving processing throughput and accuracy compared with naive string matching.

The server uses an emotion analysis engine to derive emotion state information. In one embodiment, the server invokes an external sentiment analysis service by transmitting the posting text information and receiving an emotion type and an emotion intensity. In another embodiment, the server executes an internal neural network classifier, for example a recurrent neural network or a transformer-based classifier trained on labeled emotion data. The classifier uses word embeddings and pooled contextual representations to output probability values for multiple emotion classes such as anger, joy, sadness, and neutrality. The server interprets these probabilities as intensity scores and selects the emotion type corresponding to the highest probability. The server stores the emotion type and emotion intensity alongside the aggressiveness determination information and confidentiality determination information. This structured combination allows the server to treat emotion as an explicit control signal for subsequent generative processing rather than as a passive log.

The server implements a prompt construction module that constructs a prompt sentence for a generative AI model by programmatically combining results from the preceding analysis modules. The server does not simply forward the original text to the generative AI model. Instead, the server synthesizes an instruction string that encodes: a description of the desired output (such as a warning message or a neutral rewrite), a summary of detected risk (offensiveness and confidentiality), and a description of the emotion state. This non-conventional prompt construction provides the generative AI model with structured meta-information that is not present in the raw text, thereby enabling the model to generate outputs that more precisely match the moderation context.

For example, when the server generates a warning message, the server constructs a prompt sentence such as:
“Analyze the following user post and the analysis results. The post contains aggressive expressions and the user is estimated to be angry. Generate a concise warning message that informs the user that the post may be perceived as aggressive: ‘This product is absolutely useless and the support is the worst!’”

When the server generates a correction proposal, the server constructs a prompt sentence such as:
“The following user post has been analyzed as aggressive and possibly containing confidential information. The user is estimated to be angry. Rewrite the post in a calmer, neutral tone, preserving the user's opinion but reducing offensiveness and avoiding explicit confidential details: ‘This product is absolutely useless and the support is the worst!’” In another concrete case involving confidentiality, the server constructs a prompt sentence such as:
“Abstract or remove any confidential information such as project names, organization names, and exact amounts from the following text, while preserving the overall meaning: ‘Our internal project X123 at Company ABC failed and lost 2 million dollars.“ ”

The server passes the constructed prompt sentence to the generative AI model along with model control parameters such as maximum output length and randomness settings. The generative AI model, being a transformer network with multiple self-attention layers and learned parameters, processes the prompt sentence token by token, computes attention weights across previous tokens, and outputs probabilities over the vocabulary for each subsequent token. The server decodes the output using a deterministic or controlled sampling method to produce character information for a warning message or a correction proposal. Because the server carefully structures the prompt sentence to reflect internal analysis results, the generative AI model behavior is constrained to the moderation task and does not simply perform general paraphrasing.

The server stores the generated text, together with the original posting text information and the analysis results, in a memory area associated with the current moderation session. The server then generates screen display information including the posting text information, the warning message, and any correction proposal character information, and sends this information to the terminal. The terminal, which may be a smartphone, tablet, or personal computer, uses a display unit and a user interface framework to render the original post text, the warning message, and selectable options such as “Post as is,” “Use suggested version,” and “Edit manually.” The terminal collects user input via a keyboard, touchscreen, or pointing device and transmits response information to the server.

When a user chooses to adopt a correction proposal, the server treats the correction proposal character information as candidate final posting text information. When a user chooses to edit manually, the terminal allows the user to modify the text locally, and the modified text is sent to the server as final posting text information. The server optionally performs simplified re-analysis on the final posting text information, for example by re-checking only high-severity rules or high-risk patterns, which reduces processing time and network usage compared with full re-analysis. If the simplified re-analysis indicates no critical issues, the server registers the final posting text information in an information-sharing service storage area, such as a database table or document store. The information-sharing platform then distributes the final posting text information to other users.

By structuring the system in this manner, the server improves the technical functioning of the content moderation pipeline in several ways. First, the server avoids naive direct invocation of a generative AI model by inserting an analysis-driven prompt construction stage. The server uses internal data structures that represent aggressiveness determination, confidentiality determination, and emotion state as explicit fields, and translates these fields into prompt sentences that guide the generative AI model. This reduces unnecessary model invocations, improves determinism of outputs, and reduces the amount of trial-and-error or manual tuning that would otherwise be required.

Second, the server reduces computational load and latency. By performing tokenization and rule-based filtering first, the server can bypass generative processing entirely for posts that are clearly safe under predefined thresholds. Conversely, the server can choose a shorter or simpler prompt structure for posts that exhibit only low-severity issues. As a result, the server reduces the number of tokens that must be processed by the generative AI model and thus reduces response time and resource consumption. The server can also adapt the number of attention layers or decoding steps used by the generative AI model according to risk level, further optimizing resource usage.

Third, the server improves accuracy and consistency of moderation decisions. The combination of dictionary-based detection, rule-based scoring, and emotion analysis produces a richer feature set than any single method alone. The server encodes this feature set in a way that the generative AI model can exploit via the prompt sentence, leading to warning messages and correction proposals that better match the context and the user's emotional state. This reduces false positives and false negatives relative to systems that rely solely on static rules or opaque black-box classifiers.

Fourth, the server exploits training and adaptation mechanisms of the generative AI model and emotion classifier in ways that improve computer performance over time. During a training phase, the server or a connected training system uses historical posting text information, analysis outputs, and user decisions (such as acceptance or rejection of proposed corrections) to adjust model parameters. The server uses a loss function that combines reconstruction error, content similarity measures, and penalties for residual aggressiveness or confidentiality. The server updates model weights by gradient descent-based optimization, such as stochastic gradient descent or adaptive methods, and may perform data augmentation to increase robustness, for example by paraphrasing sentences or inserting controlled noise. These training details ensure that the model is not a fixed black box but part of an engineered pipeline that is optimized for the technical task of moderation.

In certain embodiments, the server applies a rule-based gating mechanism that determines when and how to involve the generative AI model. The server uses thresholds on aggressiveness determination scores, confidentiality determination scores, and emotion intensity to select between multiple prompt templates or to skip generative rewriting entirely. This non-conventional combination of symbolic rules and neural generation results in a hybrid system that is more efficient and predictable than systems that rely solely on either rules or generative models.

In some embodiments, the server supports alternative configurations. For example, the server may use a smaller generative AI model deployed locally for low-risk posts and a larger remote model for high-risk posts, thereby balancing latency and quality. The server may alter the content of prompt sentences according to a selected policy, such as emphasizing confidentiality in enterprise environments or emphasizing politeness in social communities.

The server may also store templates for specific languages or regions and select an appropriate template based on metadata from the terminal.

The terminal and the user remain integral components of the system. The terminal presents machine-generated warnings and correction proposals alongside the original content in a transparent manner, and the user's decisions feed back into the server's internal logs and training datasets. Thus, the server, the terminal, and the user interact in a closed loop, but the core technical contribution resides in the server's internal data structures, analysis algorithms, prompt sentence construction, and controlled use of the generative AI model.

Because the server uses these specific data structures, prompt sentence constructions, and rule-guided generative processes, the system does more than automate an existing human moderation task. The system provides an improved technical mechanism for transforming unstructured text into structured analysis results, and then into constrained inputs for a generative AI model, resulting in improved processing speed, improved moderation accuracy, reduced network and compute load, and more reliable behavior of complex neural language models within a content moderation environment.

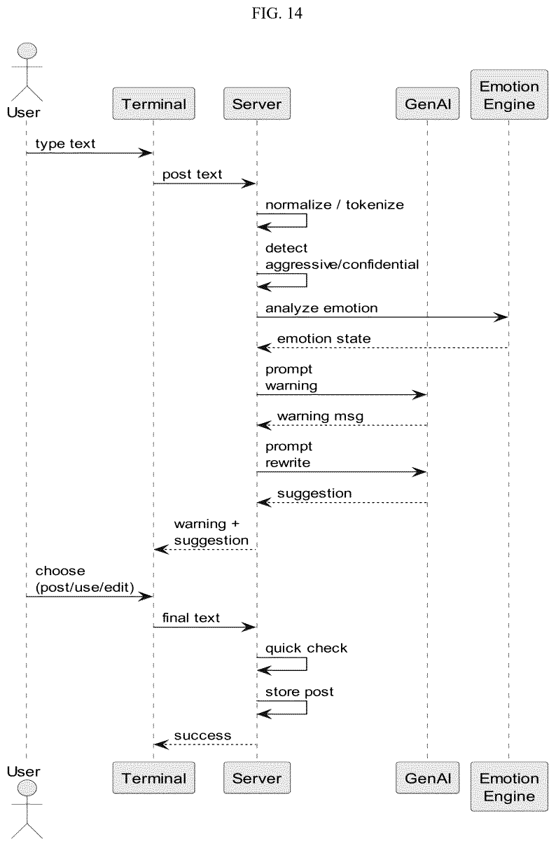

The following describes the processing flow using FIG. 14.

### Step 1:

User inputs posting text on the terminal.

User enters posting text information (for example, “This product is absolutely useless and the support is the worst!”) into a text input field provided by an application on the terminal.

Input: User's raw text characters and optional context (such as target thread ID).

Output: In-memory representation of the text and context on the terminal side.

Terminal captures the characters as a string, associates metadata (user identifier, timestamp, target resource), and temporarily stores these values in its local memory for transmission.

### Step 2:

Terminal transmits posting text information to the server.

Terminal sends an HTTP or similar network request to the server including the posting text information and context as payload data.

Input: Raw text string and context stored on the terminal.

Output: Network packet containing the text and context delivered to the server.

Terminal serializes the data into a structured format (for example, JSON fields “text”, “user_id”, “thread_id”), opens a secure connection (for example, HTTPS), and transmits the request to a predefined server endpoint.

### Step 3:

Server receives and parses the posting text information.

Server accepts the incoming network request, reads the payload, and extracts the posting text information and associated metadata into server-side variables.

Input: Network packet containing serialized text and context.

Output: Internal data structure holding the posting text string and metadata.

Server deserializes the payload, performs basic validation (for example, checking text length and allowed character set), and stores the text in a session-specific record in main memory.

### Step 4:

Server normalizes and segments the posting text information.

Server converts the posting text into a canonical internal representation and splits it into linguistic units and identification-target units using an NLP library such as spaCy or NLTK.

Input: Raw posting text string.

Output: Array or list of token objects and a set of identification-target units (such as named entities and numeric expressions).

Server performs Unicode normalization, lowercasing where appropriate, whitespace trimming, and punctuation standardization. Server then calls a tokenizer and parser, generating token objects that include surface form, lemma, part-of-speech tag, and position indices. Server identifies named entities and numeric expressions and stores them as identification-target units for later analysis.

### Step 5:

Server detects aggressiveness and confidentiality using dictionary and rule information.

Server analyzes the tokens and identification-target units to determine whether the posting text contains aggressive or confidential content.

Input: Token list, identification-target units, dictionary information, and rule information.

Output: Aggressiveness determination information and confidentiality determination information, each including flags, scores, and lists of matched items.

Server performs look-ups in offensive term dictionaries, confidential term dictionaries, and pattern rules. Server calculates scores by summing weights associated with matched words and patterns, applies thresholds defined in rule information, and sets aggressiveness and confidentiality flags accordingly. Server also records which tokens or phrases triggered the scores, storing their indices for later explanation or highlighting.

### Step 6:

Server analyzes user emotion and computes emotion state information.

Server estimates the user's emotional state from the posting text by invoking an emotion analysis engine, such as an external sentiment analysis service or an internal neural network classifier.

Input: Normalized posting text string.

Output: Emotion state information including an emotion type (for example, anger) and an emotion intensity value or level.

Server sends the text to the emotion analysis component, receives probability scores over predefined emotion classes, selects the highest-scoring class as the emotion type, and interprets the magnitude as emotion intensity. Server then attaches the resulting emotion type and intensity to the same record that holds the aggressiveness and confidentiality determination information.

### Step 7:

Server determines whether a warning is required and selects a warning style.

Server combines the aggressiveness determination information, confidentiality determination information, and emotion state information to decide whether the posting text is a target for warning and how the warning should be expressed.

Input: Aggressiveness determination information, confidentiality determination information, and emotion state information.

Output: Warning requirement flag, selected warning type, and selected expression style parameters.

Server evaluates rule conditions such as “aggressiveness score above threshold” or “confidentiality score above threshold.” If any condition is satisfied, server sets the warning requirement flag. Server then examines emotion type and intensity—for example, high anger—and chooses a warning type (aggressiveness-focused, confidentiality-focused, or combined) and expression style (more cautious or more explanatory), storing these choices as parameters for subsequent message generation.

### Step 8

Server constructs a warning-generation prompt sentence for the generative AI model.

Server uses the analysis results and selected warning style to build an instruction text (prompt sentence) that directs the generative AI model to generate an appropriate warning message.

Input: Posting text, aggressiveness determination information, confidentiality determination information, emotion state information, and selected warning style.

Output: Warning-generation prompt sentence as a text string.

Server concatenates template phrases with dynamic elements such as detected risk types and emotion description. For example, server constructs:
“Analyze the following user post and the analysis results. The post contains aggressive expressions and the user is estimated to be angry. Generate a concise warning message that informs the user that the post may be perceived as aggressive: ‘This product is absolutely useless and the support is the worst!’”

Server formats this prompt sentence according to the input specification of the generative AI model, ensuring that the instruction and the quoted post are clearly separated.

### Step 9:

Server invokes the generative AI model to generate a warning message.

Server sends the constructed prompt sentence and control parameters (such as maximum length and decoding temperature) to a generative AI model implemented as a transformer-based neural network.

Input: Warning-generation prompt sentence and model control parameters.

Output: Character information for the warning message (generated warning text).

Server transmits the prompt sentence through an API call, receives the model's token sequence output, and decodes it into a string. Server may post-process the generated text to remove extraneous characters or limit length, and stores the final warning message string in the moderation record.

### Step 10:

Server decides whether to prepare a correction proposal and, if needed, constructs a correction-instruction prompt sentence.

Server determines, based on the analysis results and system policy, whether to request a correction proposal from the generative AI model, and if so, builds an appropriate prompt sentence for rewriting.

Input: Posting text, aggressiveness determination information, confidentiality determination information, emotion state information, and policy settings.

Output: Decision flag for correction proposal and, when positive, a correction-instruction prompt sentence.

Server checks conditions such as high aggressiveness score, presence of confidential terms, or high anger intensity. If conditions are met, server constructs an instruction such as:
“The following user post has been analyzed as aggressive and possibly containing confidential information. The user is estimated to be angry. Rewrite the post in a calmer, neutral tone, preserving the user's opinion but reducing offensiveness and avoiding explicit confidential details: ‘This product is absolutely useless and the support is the worst!’” Server stores this prompt sentence for subsequent use with the generative AI model.

### Step 11:

Server invokes the generative AI model to generate a correction proposal.

Server sends the correction-instruction prompt sentence to the generative AI model to obtain a revised version of the posting text.

Input: Correction-instruction prompt sentence and model control parameters.

Output: Correction proposal character information (rewritten text).

Server calls the same or a different generative AI model instance with the constructed prompt. The model computes contextual embeddings, attention scores, and token probabilities, and outputs a revised sentence, for example: “This product did not meet my expectations, and I feel that the support service could be improved.” Server decodes and, if necessary, sanitizes the text, then stores it as a candidate correction proposal linked to the original text.

### Step 12:

Server composes screen display information for the terminal.

Server prepares a response payload including the original posting text, the generated warning message, any correction proposal, and user selection options.

Input: Original posting text, warning message string, optional correction proposal string, and UI policy.

Output: Screen display information containing text elements and option definitions.

Server formats this data into a structured response (for example, with fields specifying which strings to show and what buttons to present, such as “Post as is,” “Use suggested version,” “Edit manually,” and “Cancel”), then sends it back to the terminal over the network.

### Step 13:

Terminal displays the warning and options to the user.

Terminal renders the received screen display information on its display unit, showing the original text, the warning message, and any correction proposal, along with selectable buttons.

Input: Screen display information from the server.

Output: Visual user interface elements and an internal representation of possible user actions.

Terminal maps the text strings to UI components (labels, text areas) and binds the options to interaction controls (buttons or menu items). Terminal waits for the user to make a selection and records the selected option and any edited text.

### Step 14:

User reviews the information and selects an action.

User reads the warning message, the original text, and any correction proposal, and then decides how to proceed.

Input: Visual presentation of original text, warning message, and correction proposal.

Output: User decision (such as posting continuation, correction adoption, or re-editing) and, in case of re-editing, modified text.

User may choose “Post as is,” “Use suggested version,” or “Edit manually.” If the user edits manually, the user modifies the text in the input field and confirms submission, producing a new version of the text.

### Step 15:

Terminal sends response information and final text to the server.

Terminal packages the user's decision and any resulting final text into a response message and transmits it to the server.

Input: User decision and final text state on the terminal.

Output: Response information received by the server, including final posting text information.

Terminal creates a structured payload including a decision code (for example, “continue_original,” “adopt_correction,” or “manual_edit”) and the corresponding text content, then sends this payload over the network to a designated server endpoint.

### Step 16:

Server determines the final posting text and optionally performs simplified re-analysis.

Server interprets the user decision, selects the appropriate text as final posting text information, and may perform a reduced set of checks to confirm that no critical risks remain.

Input: Response information and previously stored analysis results and corrections.

Output: Confirmed final posting text information suitable for registration.

Server, for example, selects the correction proposal text when the user adopts it, or uses the manually edited text when the user chooses re-editing. Server may re-run only high-priority rules or quick pattern checks on the final text, using the same dictionary and rule information but skipping full scoring and emotion analysis to reduce computation time. If no critical issues are detected, server flags the text as approved for posting.

### Step 17:

Server registers the final posting text information in the information-sharing service storage area.

Server stores the approved final posting text information in a persistent storage structure associated with the information-sharing platform, such as a database table for posts.

Input: Confirmed final posting text information and related metadata.

Output: Persistent record representing the posted content on the platform.

Server constructs a database insertion or update command including fields for user identifier, timestamp, thread identifier, and final text. Server executes the command, commits the transaction, and generates an identifier for the new or updated post.

### Step 18:

Server notifies the terminal of successful posting.

Server sends a success response to the terminal indicating that the final posting text has been registered on the information-sharing platform.

Input: Result of the registration operation (for example, post ID and status).

Output: Success message and optional post metadata transmitted to the terminal.

Server includes in the response a status field (such as “success”), the newly assigned post identifier, and possibly the stored final text for confirmation.

### Step 19:

Terminal updates the user interface to reflect the posted content.

Terminal receives the success response and refreshes the display to show the final posted text in the appropriate location within the platform interface.

Input: Success response containing post ID and final text.

Output: Updated on-screen representation of the information-sharing platform including the new or updated post.

Terminal inserts or updates the post in the feed or conversation view, associates any server-provided identifier for future operations (such as editing or deletion), and may show a confirmation message (such as “Your post has been published”) to the user.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

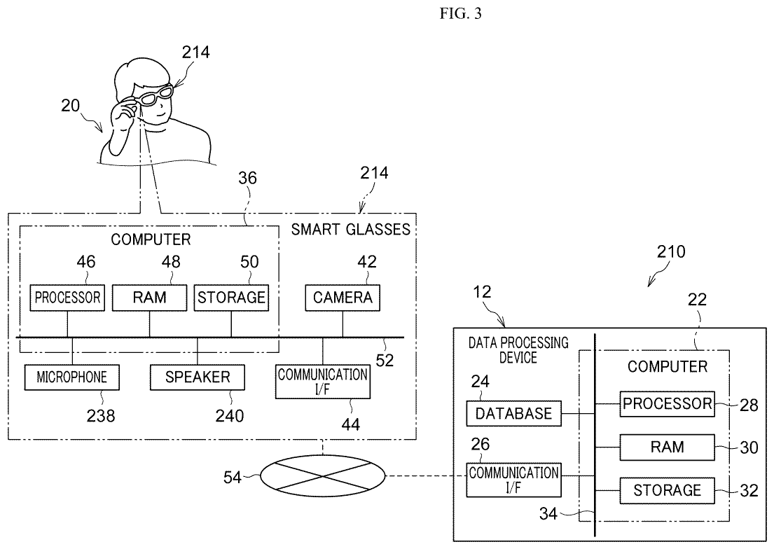

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

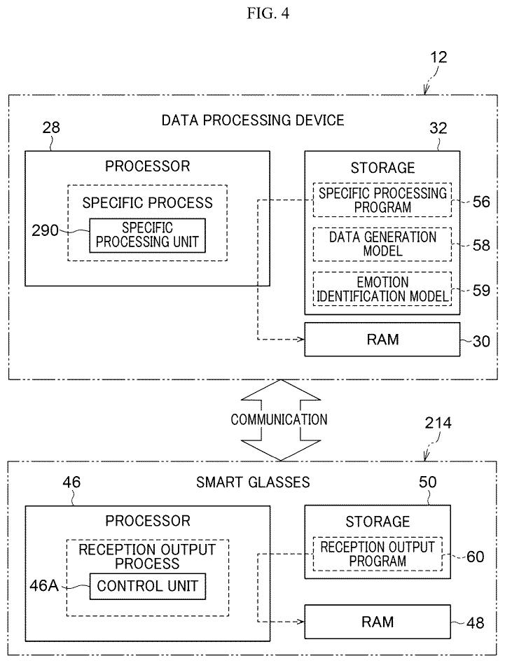

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

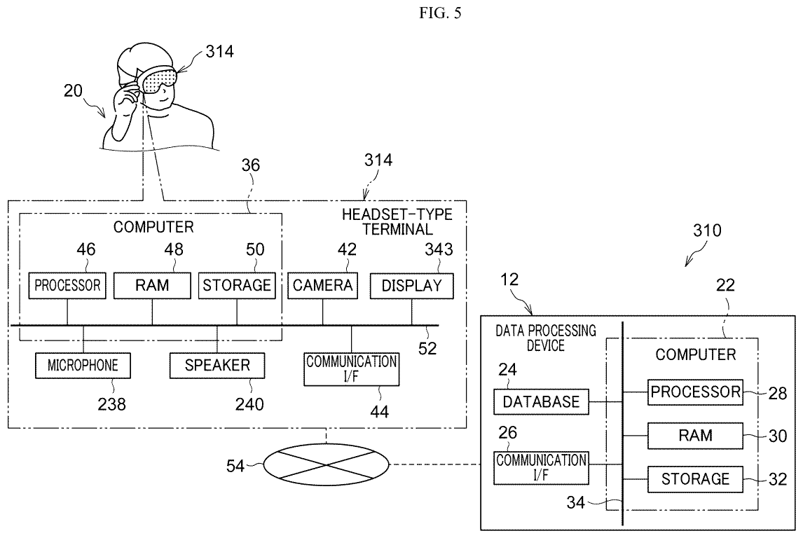

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

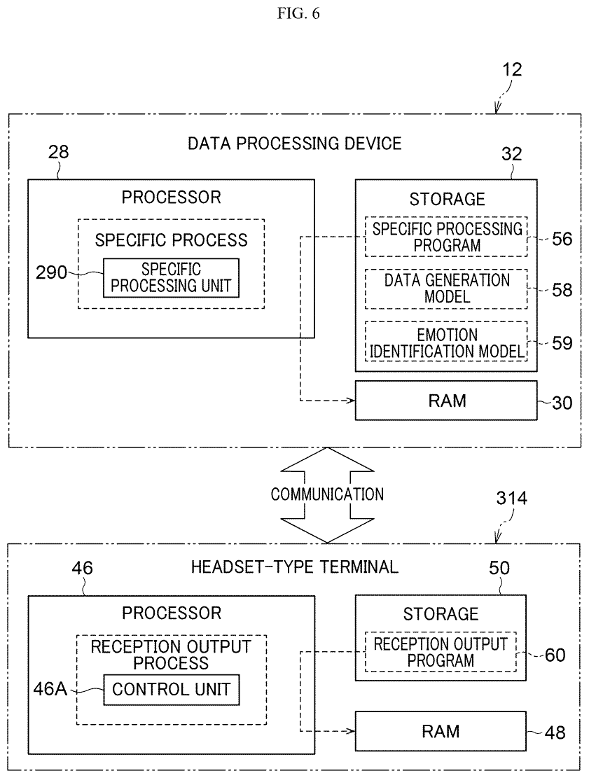

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

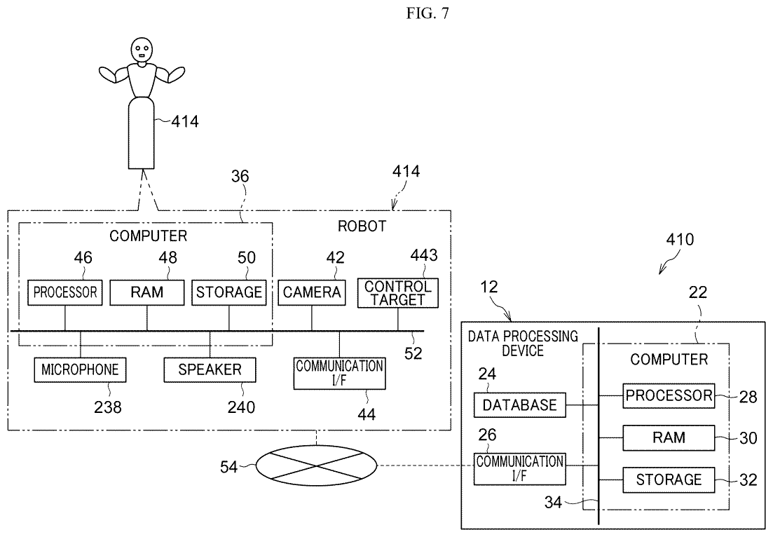

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

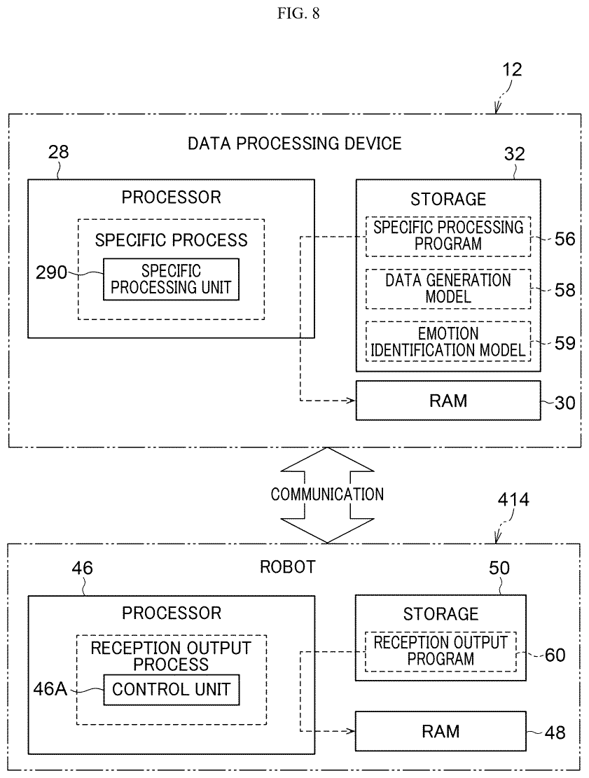

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

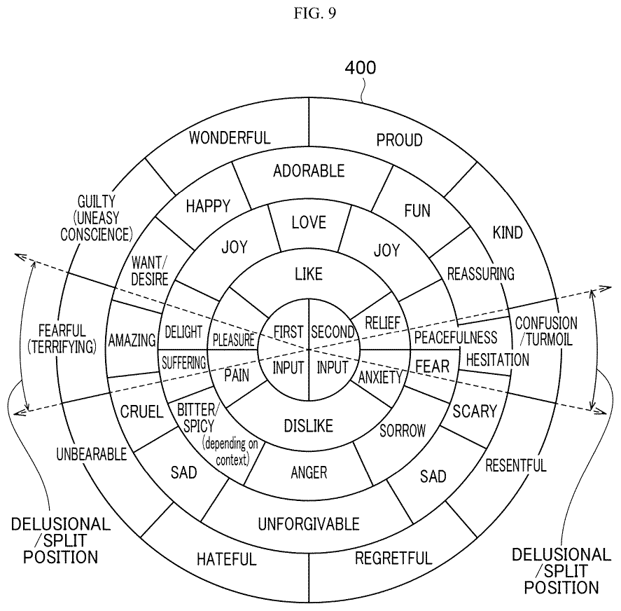

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles.

Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University).

Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

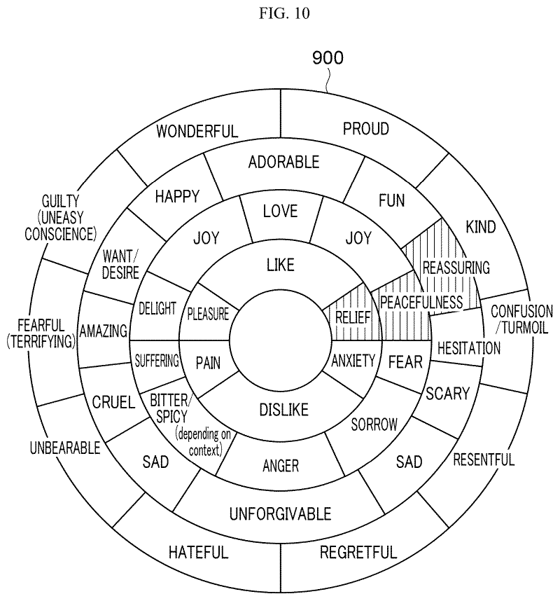

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC).

Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure.

Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive posting text information from a user terminal associated with an information sharing platform, input the posting text information to a text information analysis unit using a natural language processing technique, and perform morphological analysis, punctuation processing, normalization processing, and syntactic analysis to extract a word sequence and a phrase sequence from the posting text information,
compare the extracted word sequence and phrase sequence with word information stored in a word information storage unit, the word information storage unit storing word information corresponding to offensive content and confidential content, apply rule-expression patterns related to confidential content to the posting text information to detect structured number information and identification information, and extract candidate information corresponding to offensive content or confidential content,
generate a prompt sentence for instructing a generative artificial intelligence model to generate warning text information for providing a caution to the user on the basis of the candidate information extracted by the detection, transmit the prompt sentence to the generative artificial intelligence model, obtain the warning text information generated by the generative artificial intelligence model, and transmit the warning text information to the user terminal for display,
adjust, on the basis of the candidate information extracted by the detection and an emotion analysis result obtained by an emotion analysis engine that analyzes an emotional state of the user on the basis of an input operation history or biological information of the user, at least one of a word configuration and an output condition of the prompt sentence to be input to the generative artificial intelligence model, and change at least one of an expression intensity and an expression style of the warning text information,
when the user selects execution of posting after the warning text information is displayed, generate correction conditions including the candidate information extracted by the detection and the emotion analysis result, generate a correction prompt sentence for instructing the generative artificial intelligence model to generate a correction proposal that reduces at least one of aggressiveness and confidentiality of the posting text information on the basis of the correction conditions, transmit the correction prompt sentence to the generative artificial intelligence model, obtain the correction proposal generated by the generative artificial intelligence model, and present the correction proposal to the user terminal,
associate at least one of corrected posting text information transmitted from the user terminal and posting text information selected by the user to be posted without correction with a detection result of the detection and the emotion analysis result, and record the association as history information in a storage unit, and
update, on the basis of the history information, at least one of the word information stored in the word information storage unit and configuration conditions of the prompt sentence so as to improve detection accuracy of the offensive content or the confidential content and generation accuracy of the correction proposal.

### (Supplementary 2)

The system according to supplementary 1,
wherein the processor is configured to
configure the prompt sentence such that the warning text information includes a text in a format of “This post may be perceived as offensive. Do you still want to post it?” or “This post may contain confidential information. Do you still want to post it?”, and control the generative artificial intelligence model to generate the warning text information in accordance with the format.

### (Supplementary 3)

The system according to supplementary 1,
wherein the processor is configured to
include, in the prompt sentence, a condition that requests the generative artificial intelligence model to rewrite an overall expression of the posting text information into a calmer expression and to delete or generalize the confidential content when the emotional state of the user obtained by the emotion analysis engine indicates at least one of a high anger level and a high stress level, and cause the generative artificial intelligence model to automatically generate the correction proposal that reduces at least one of the aggressiveness and the confidentiality of the posting text information.

### Application Example 1

### (Supplementary 1)

A system comprising a processor,
wherein the processor is configured to
acquire character string data representing a posting draft transmitted from a user terminal, and perform preprocessing on the character string data by using a natural language processing technique to segment the character string data into units including at least one of morpheme units and phrase units,
compare words and consecutive words included in the preprocessed character string data with dictionary information stored in a storage device, the dictionary information storing vocabulary information associated with offensive expressions and confidential information, and with regular expression information representing patterns of confidential information, determine presence or absence and position information of the offensive expressions or the confidential information in the character string data, and generate detection result data including a determination result and a risk level,
construct, on the basis of the detection result data, a prompt sentence that defines warning content and a modification policy in accordance with whether posting content is offensive or confidential, and generate the prompt sentence as input data to a generative artificial intelligence model,
transmit the prompt sentence to the generative artificial intelligence model, acquire, from the generative artificial intelligence model, response character string data serving as a candidate modification proposal for reducing offensiveness or confidentiality of the posting content, and, when necessary, re-compare the response character string data with the dictionary information and the regular expression information to inspect remaining presence of the offensive expressions or the confidential information in the response character string data, specify, on the basis of the detection result data and the response character string data, problem portions included in the posting draft as display position information, generate display control information for visually emphasizing the problem portions, and generate presentation information including a warning message indicating a possibility that the posting content is offensive or confidential and including the modification proposal candidate, and transmit the presentation information to the user terminal,
receive, from the user terminal, at least one of an acceptance or a rejection of the modification proposal candidate and modified character string data edited by a user, execute again the preprocessing and the comparison for the modified character string data, determine whether the modified character string data satisfies a predetermined criterion, and generate, on the basis of a determination result, posting permission information or additional warning information, and
generate transmission control information for transmitting the modified character string data to an information sharing service on the basis of the posting permission information.

### (Supplementary 2)

The system according to supplementary 1,
wherein the processor is configured to
cause the warning message included in the presentation information to be displayed in a format including at least one of a message of “There is a possibility that this may be perceived as offensive. Do you still want to send it?” and a message of “There is a possibility that this may include confidential information. Do you still want to send it?”.

### (Supplementary 3)

The system according to supplementary 1,
wherein the processor is configured to
change, in accordance with at least one of a type and a risk level of the offensive expressions or the confidential information included in the detection result data, at least one of the modification policy, tone, type of information to be concealed, and modification strength within the prompt sentence, and thereby generate a prompt sentence that dynamically controls a generation condition of the modification proposal for reducing the offensiveness or the confidentiality of the posting content by the generative artificial intelligence model.

### Example 2

### (Supplementary 1)

A system comprising a processor,
wherein the processor is configured to
acquire, from a terminal, post information transmitted in an information sharing service and analyze the post information by using natural language processing to obtain analysis data, normalize a character string of the post information to obtain normalized text and generate a prompt sentence including the normalized text, the prompt sentence being configured as input information to a generative AI model,
transmit, to the generative AI model, evaluation request data including the prompt sentence and acquire, from the generative AI model, evaluation result data indicating presence or absence of offensiveness or confidentiality of the post information and a reason related to the evaluation,
parse the evaluation result data in a machine-readable format, generate at least one determination flag indicating whether the post information includes offensive content or confidential content, and determine, based on the at least one determination flag, a necessity and a type of a warning message,
generate, in accordance with a determination result, a warning message indicating at least one of a possibility of offensive content or a possibility of confidential content, transmit the warning message and the post information to the terminal, and cause the terminal to display the warning message as an interactive screen,
acquire, from the terminal, response information including a selection result of a user regarding continuation or cancellation of posting in response to the warning message, and when the selection result indicates continuation of posting, record the post information in a publication storage region of the information sharing service, and when the selection result indicates cancellation of posting, control so as not to record the post information,
obtain, by using an emotion analysis processing unit, analysis result information regarding an emotional state of the user, and adjust expression content or intensity of the warning message based on at least one of the analysis result information and the evaluation result data, and, when the selection result indicates continuation of posting and the at least one
determination flag indicates presence of at least one of offensive content or confidential content, generate a correction prompt sentence that instructs the generative AI model to generate a modification proposal that reduces offensiveness or confidentiality of the post information, transmit the correction prompt sentence to the generative AI model to acquire modification proposal data, and transmit the modification proposal data to the terminal to be presented.

### (Supplementary 2)

The system according to supplementary 1,
wherein the processor is configured to cause the warning message to be displayed on the terminal in a format including wording corresponding to the at least one determination flag, the wording including at least one of “This post may be perceived as offensive. Do you still want to post it?” or “This post may contain confidential information. Do you still want to post it?”

### (Supplementary 3)

The system according to supplementary 1,
wherein the processor is configured to modify, in accordance with the analysis result information regarding the emotional state of the user, at least one of a correction policy or a tone of corrected text in the correction prompt sentence, and thereby cause the modification proposal data generated by the generative AI model to reflect the modification.

### Application Example 2

### (Supplementary 1)

A system comprising a processor,
wherein the processor is configured to
acquire posting text information transmitted from a user terminal, perform preprocessing on the posting text information to normalize and segment the posting text information to generate a sequence of linguistic units and a sequence of identification-target units, and analyze the sequence of linguistic units and the sequence of identification-target units on the basis of dictionary information and rule information to determine whether the posting text information includes aggressiveness information and confidentiality information, and to generate aggressiveness determination information and confidentiality determination information,
to input the posting text information into an emotion analysis engine to execute an emotion estimation process, to acquire emotion state information including an emotion type and an emotion intensity, and to associate and store the emotion state information together with the aggressiveness determination information and the confidentiality determination information, to determine, on the basis of at least one of the aggressiveness determination information and the confidentiality determination information, whether the posting text information is a target for warning, to determine a type and an expression style of warning content on the basis of the emotion state information, and to generate a warning message including warning wording corresponding to a result of the determination,
to construct, as instruction information, a prompt sentence for performing or adjusting generation of the warning message using a generative AI model, the prompt sentence including at least a part of the posting text information, the aggressiveness determination information, the confidentiality determination information, and the emotion state information,
to instruct input of the prompt sentence into the generative AI model, and to acquire character information for the warning message output from the generative AI model and adopt the character information as the warning message,
to transmit, to the user terminal, screen display information including the posting text information, the warning message, and user selection option information, and to receive response information including at least one of a posting continuation instruction, a correction adoption instruction, and a re-editing instruction from a user,
to, when a correction of posting content is selected in the response information, generate a correction-instruction prompt sentence including at least a part of the posting text information, the aggressiveness determination information, the confidentiality determination information, and the emotion state information, to instruct input of the correction-instruction prompt sentence into the generative AI model, to acquire correction proposal character information output from the generative AI model, and to present the correction proposal character information to the user terminal, and
to acquire final posting text information transmitted from the user terminal, to optionally perform simplified re-analysis on the final posting text information, and to register the final posting text information in a storage area for an information-sharing service so as to post the final posting text information to an information-sharing platform.

### (Supplementary 2)

The system according to supplementary 1,
wherein the processor is configured to, as the warning message, generate a message including wording in a form of “There is a possibility that this post will be perceived as aggressive. Do you still want to post it?” in accordance with the aggressiveness determination information, or to generate a message including wording in a form of “There is a possibility that this post contains confidential information. Do you still want to post it?” in accordance with the confidentiality determination information, and to construct the prompt sentence for the generative AI model so as to add, to the message, an expression indicating that the user is estimated to be angry when the emotion state information indicates high anger.

### (Supplementary 3)

The system according to supplementary 1,
wherein the processor is configured to construct the correction-instruction prompt sentence so as to instruct the generative AI model to convert aggressive expressions into neutral expressions while maintaining subjective evaluation content of the posting text information, and to convert specific information having high confidentiality into abstract information on the basis of the emotion type and the emotion intensity included in the emotion state information, and to cause the generative AI model to generate the correction proposal character information in consideration of the emotion state information.

What is claimed is:

1. A system comprising:
circuitry configured to:
acquire character string data representing a posting draft from a user terminal;
preprocess the character string data using a natural language processing component to segment the character string data into linguistic units comprising at least one of morpheme units and phrase units;
compare the preprocessed character string data with dictionary information stored in a storage device and with regular expression information, wherein the dictionary information associates vocabulary entries with offensive expressions and confidential information patterns, to determine presence or absence and position information of offensive expressions or confidential information in the character string data and generate detection result data comprising a determination result and a risk level;
construct a prompt sentence defining warning content and a modification policy based on the detection result data;
transmit the prompt sentence to a generative artificial intelligence model and acquire response character string data comprising a candidate modification proposal for the posting draft;
re-compare the response character string data with the dictionary information and the regular expression information to inspect remaining presence of offensive expressions or confidential information in the candidate modification proposal;
generate display control information specifying problem portions in the posting draft as display position information for visually emphasizing the problem portions, and generate presentation information comprising a warning message and the candidate modification proposal; and
transmit the presentation information to the user terminal.

2. The system of claim 1, wherein the circuitry is configured to:
receive from the user terminal at least one of an acceptance or a rejection of the candidate modification proposal and modified character string data edited by a user;
execute the preprocessing and the comparison for the modified character string data;
determine whether the modified character string data satisfies a predetermined safety criterion; and
generate posting permission information or additional warning information based on the determination result.

3. The system of claim 2, wherein the circuitry is configured to:
apply an emotion recognition model to at least one of the character string data and user input information from the user terminal to determine an emotional state of the user; and
adjust at least one of the warning message and the candidate modification proposal based on the determined emotional state to present the warning and revision content in a tone appropriate for the emotional state.

4. The system of claim 3, wherein the emotion recognition model applies at least one of a lexicon-based scoring algorithm and a transformer-based sentiment classifier to the character string data to compute an emotional state score associated with at least one of an angry state, a distressed state, a neutral state, and a calm state.

5. The system of claim 4, wherein adjusting the warning message based on the emotional state comprises selecting a warning tone template indexed by emotional state category, wherein warning tone templates associated with angry or distressed states apply empathetic framing instructions in the prompt sentence to direct the generative artificial intelligence model to generate de-escalating revision suggestions.

6. The system of claim 1, wherein the natural language processing component applies at least one of a morphological analyzer, a part-of-speech tagger, and a phrase chunker to the character string data to generate the linguistic units.

7. The system of claim 6, wherein generating the linguistic units comprises applying tokenization to segment the character string data into word tokens, applying the morphological analyzer to assign morphological attributes to each word token, and applying the phrase chunker to identify phrase boundaries in the word token sequence.

8. The system of claim 1, wherein comparing the preprocessed character string data with dictionary information comprises performing a token-level lookup in which each token of the preprocessed character string data is matched against vocabulary entries in the dictionary information to identify tokens associated with offensive expression labels or confidential information labels.

9. The system of claim 8, wherein comparing the preprocessed character string data with regular expression information comprises applying a set of compiled regular expression patterns to the character string data to detect character sequences matching patterns of confidential information including at least one of identification numbers, contact information formats, and account identifier formats.

10. The system of claim 1, wherein the detection result data further comprises a position annotation mapping each detected offensive expression or confidential information occurrence to a character offset range in the character string data, and wherein the display position information is derived from the position annotation.

11. The system of claim 10, wherein generating display control information comprises encoding the position annotation as a set of display markup instructions that specify a visual emphasis style for each problem portion identified by the position annotation.

12. The system of claim 1, wherein constructing the prompt sentence comprises embedding the detection result data, the risk level, and the linguistic units surrounding detected problem portions into a structured prompt template that instructs the generative artificial intelligence model to generate revised text preserving the original semantic intent of the posting draft.

13. The system of claim 12, wherein the structured prompt template includes a modification policy section that distinguishes between an offensive content modification policy and a confidential information modification policy, and applies a corresponding revision instruction based on whether the detection result data indicates offensive expressions or confidential information.

14. The system of claim 2, wherein the predetermined safety criterion is satisfied when the modified character string data contains no tokens matching offensive expression entries in the dictionary information and no character sequences matching confidential information patterns in the regular expression information.

15. The system of claim 2, wherein generating posting permission information comprises generating transmission control information for transmitting the modified character string data to an information sharing service upon satisfaction of the predetermined safety criterion.

16. The system of claim 1, wherein the generative artificial intelligence model is a large language model accessed via a network interface, and wherein transmitting the prompt sentence comprises sending a prompt request payload to the generative artificial intelligence model via an application programming interface.

17. The system of claim 1, wherein the circuitry is configured to:
record an iteration history comprising successive versions of the posting draft, corresponding detection result data, and candidate modification proposals in the storage device, associating each iteration with a timestamp and a risk level transition record.

18. A system comprising:
circuitry configured to:
acquire character string data representing a posting draft from a user terminal;
preprocess the character string data using a natural language processing component to segment the character string data into linguistic units;
compare the preprocessed character string data with dictionary information and regular expression information to determine presence or absence of offensive expressions or confidential information and generate detection result data comprising a determination result and a risk level;
construct a prompt sentence based on the detection result data and transmit the prompt sentence to a generative artificial intelligence model to obtain response character string data comprising a candidate modification proposal;
re-compare the response character string data with the dictionary information and the regular expression information, generate display control information specifying problem portions as display position information, and transmit presentation information comprising a warning message and the candidate modification proposal to the user terminal; and
apply an emotion recognition model to at least one of the character string data and user input information to determine an emotional state and adjust at least one of the warning message and the candidate modification proposal based on the emotional state.

19. The system of claim 18, wherein the circuitry is configured to apply a token-level lookup against the dictionary information and a compiled regular expression pattern match against the character string data to detect offensive expressions and confidential information patterns, and to construct the prompt sentence by embedding the detection result data and the risk level into a structured prompt template that instructs the generative artificial intelligence model to generate revised text preserving the original semantic intent of the posting draft.

20. A method performed by circuitry, the method comprising:
acquiring character string data representing a posting draft from a user terminal;
preprocessing the character string data using a natural language processing component to segment the character string data into morpheme units or phrase units;
comparing the preprocessed character string data with dictionary information and regular expression information to determine presence or absence of offensive expressions or confidential information and generating detection result data comprising a determination result and a risk level;
constructing a prompt sentence defining warning content and a modification policy based on the detection result data and transmitting the prompt sentence to a generative artificial intelligence model to acquire response character string data comprising a candidate modification proposal;
re-comparing the response character string data with the dictionary information and the regular expression information;
applying an emotion recognition model to at least one of the character string data and user input information to determine an emotional state and adjusting at least one of the warning message and the candidate modification proposal based on the emotional state; and
generating posting permission information or additional warning information based on whether modified character string data satisfies a predetermined safety criterion.
